(19) United States
(12) Patent Application Publication
(10) Pub. No.: US 2007/0076244 A1
(43) Pub. Date: Apr. 5, 2007

(54) Electronic apparatus, electronic apparatus system, control method and computer-readable storage medium

(76) Inventors: Masahiro Suzuki, Tokyo (JP); Satoru Sugishita, Tokyo (JP); Yoko Sugiura, Kanagawa (JP); Hiroshi Baba, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/579,388

(22) PCT Filed: Sep. 12, 2005
(86) PCT No.: PCT/JP05/17208

§ 371 Date: May 15, 2006

(30) Foreign Application Priority Data
Sep. 17, 2004 (JP) 2004-272152
Sep. 1, 2005 (JP) 2005-253028

(51) Int. Cl. G06F 3/12

(52) U.S. Cl. 358/1.15

(57) ABSTRACT

An electronic apparatus is adapted to execute an operation using an application, and is provided with an communicating part for communicating with an external apparatus via a communication line, and a controlling part for executing an operation using an application within the external apparatus by communicating with the external apparatus by the communicating part.

### TECHNICAL FIELD

The present invention generally relates to electronic apparatus systems, electronic apparatuses therefor, control methods and computer-readable storage media and more particularly to an electronic apparatus such as an image processing apparatus (image reading apparatus such as a scanner apparatus, digital copying apparatus, printers, facsimile apparatus, digital composite apparatus or digital multi function peripheral, etc.), an electronic apparatus system provided with an external apparatus that connects to such an electronic apparatus via a communication line, a control method for such an electronic apparatus, and a computer-readable storage medium which stores a program for causing a computer to function as such an electronic apparatus.

### BACKGROUND ART

Recently, an image forming apparatus having a plurality of functions (or facilities), such as a digital composite apparatus or digital multifunction peripheral (MFP) has become popular among users. The image forming apparatus having the plurality of functions combines an image forming part (plotter part), an image reading part (scanner part), a facsimile (FAX) communication part, an image processing part (controller) and the like, so as to enable free selection of functions of facilities such as a copy function, a printer function, a scanner function and a facsimile function.

Conventionally, the image forming apparatus having the plurality of functions is generally designed based on a copying apparatus, and is operated as a printer or a scanner by using all or a portion of the functions thereof, and is used as a facsimile apparatus by adding a facsimile communication part.

In order to enable free selection and execution of each of such functions, it is necessary to provide an application for each of such functions so as to realize such functions, as proposed in a Japanese Laid-Open Patent Application No. 2002-84383, for example.

The “application” refers to an application software or an application program. The application is a part forming a user interface, and realizes the function to be provided to the user. Examples of the applications include an application (copy application) for realizing the copy function, an application (printer application) for realizing the printer function, an application (scanner application) for realizing the scanner function, and an application (facsimile application) for realizing the facsimile function.

However, in the image forming apparatus having the plurality of functions described above, the cost of the image forming apparatus increases if all of the applications for realizing the functions to be utilized are implemented. In addition, as the number of applications that are implemented in the image forming apparatus increases, the number of times a service person must carry out an operation of updating versions of the applications (functions) increases.

### DISCLOSURE OF THE INVENTION

It is a general object of the present invention to provide an electronic apparatus system, an electronic apparatus therefor, a control method and a computer-readable storage medium, in which the problems described above are suppressed.

A more specific object of the present invention is to provide an electronic apparatus system, an electronic apparatus therefor, a control method and a computer-readable storage medium, which can reduce the cost when realizing a plurality of functions in the electronic apparatus such as an image forming apparatus, and reduce the operation of updating versions of the applications.

Still another object of the present invention is to provide an electronic apparatus for executing an operation using an application, comprising communicating means for communicating with an external apparatus via a communication line; and controlling means for executing an operation using an application within the external apparatus by communicating with the external apparatus by the communicating means. According to the electronic apparatus of the present invention, it is possible to reduce the cost when realizing a plurality of functions in the electronic apparatus, and to reduce the operation of updating versions of the applications, because a common application may be used in common among a plurality of electronic apparatuses.

A further object of the present invention is to provide an electronic apparatus system in which an electronic apparatus and an external apparatus are communicatably coupled via a communication line, where the electronic apparatus is for executing an operation using an application and comprises communicating means for communicating with an external apparatus via a communication line, controlling means for executing an operation using an application within the external apparatus by communicating with the external apparatus by the communicating means, device start notification sending means for sending a start notification of the electronic apparatus to the external apparatus by the communicating means, and application information registering means for registering information related to a usable application that is added to an application usability notification, when the application usability notification from the external application is received by the communicating means in response to the start notification sent by the device start notification sending means, and wherein the external apparatus comprises application storing means; an other communicating means for communicating with the electronic apparatus via the communication line; and application usability notification sending means for adding information that is related to the usable application and is stored in the application storing means to the application usability notification before sending the application usability notification to the electronic apparatus by the other communicating means, when the other communicating means receives the start notification from the electronic apparatus. According to the electronic apparatus system of the present invention, it is possible to reduce the cost when realizing a plurality of functions in the electronic apparatus, and to reduce the operation of updating versions of the applications, because a common application may be used in common among a plurality of electronic apparatuses.

Another object of the present invention is to provide a control method for an electronic apparatus which executes an operation using an application, comprising communicating with an external apparatus via a communication line; and executing an operation using an application within the external apparatus. According to the control method of the present invention, it is possible to reduce the cost when realizing a plurality of functions in the electronic apparatus, and to reduce the operation of updating versions of the applications, because a common application may be used in common among a plurality of electronic apparatuses.

Still another object of the present invention is to provide a computer-readable storage medium which stores a program for causing a computer of an electronic apparatus to execute an operation using an application, said program comprising procedures for causing the computer to realize a communicating function for communicating with an external apparatus via a communication line; and a controlling function for executing an operation using an application within the external apparatus by communicating with the external apparatus by the communicating function. According to the computer-readable storage medium of the present invention, it is possible to reduce the cost when realizing a plurality of functions in the electronic apparatus, and to reduce the operation of updating versions of the applications, because a common application may be used in common among a plurality of electronic apparatuses.

Other objects and further features of the present invention will be apparent from the following detailed description when read in conjunction with the accompanying drawings.

### BRIEF DESCRIPTION OF THE DRAWINGS

FIG. 1 is a diagram generally showing an example of a network connection of an image forming system;

FIG. 2 is a system block diagram showing a hardware structure of a MFP shown in FIG. 1;

FIG. 3 is a system block diagram showing a functional structure of an important part of the MFP shown in FIG. 1 of a first embodiment;

FIG. 4 is a system block diagram showing a hardware structure of an external server shown in FIG. 1;

FIG. 5 is a system block diagram showing a functional structure of an important part of the MFP shown in FIG. 1 and the external server;

FIG. 6 is a diagram showing a first example of a communication sequence between the MFP shown in FIG. 3 and an external application when the MFP is started;

FIG. 7 is a diagram showing a structure of commands exchanged between the MFP shown in FIG. 3 and the external applications;

FIG. 8 is a diagram showing contents of an application management table;

FIG. 9 is a diagram showing a second example of the communication sequence between the MFP shown in FIG. 3 and the external application when the MFP is started, in order to enable execution of the application;

FIG. 10 is a diagram showing a first example of the communication sequence between the external application and the MFP shown in FIG. 3 when an application connection request command is issued from the external application;

FIG. 11 is a diagram showing a second example of the communication sequence between the external application and the MFP shown in FIG. 3 when the application connection request command is issued from the external application;

FIG. 12 is a diagram for explaining information related to the image processing apparatus, including a device identification number stored in a device information storing part shown in FIG. 5;

FIG. 13 is a diagram for explaining more detailed information related to the image processing apparatus stored in the device information storing part shown in FIG. 5;

FIG. 14 is a diagram showing a third example of the communication sequence between the external application and the MFP shown in FIG. 3 when the application connection request command is issued from the external application;

FIG. 15 is a diagram showing an example of a warning screen displayed on an operation part shown in FIG. 4;

FIG. 16 is a diagram showing an example of a screen for notifying the image processing apparatus used by the external application shown in FIG. 3 to the user;

FIG. 17 is a diagram showing an example of a screen displaying a list of information related to image processing apparatuses connected to the network;

FIG. 18 is a system block diagram showing another functional structure of the important part of the MFP shown in FIG. 1;

FIG. 19 is a system block diagram showing still another functional structure of the important part of the MFP shown in FIG. 1;

FIG. 20 is a system block diagram showing a functional structure of an important part of the MFP of a second embodiment;

FIG. 21 is a diagram showing a first example of the communication sequence between the external application and the MFP shown in FIG. 20 when an operation execution request command is issued from the external application;

FIG. 22 is a diagram showing a structure of commands exchanged between the MFP shown in FIG. 20 and the external applications;

FIG. 23 is a diagram showing a second example of the communication sequence between the external application and the MFP shown in FIG. 20 when the operation execution request command is issued from the external application;

FIG. 24 is a flow chart for explaining a process of a CPU within a controller of the MFP shown in FIG. 20 when the operation execution request command is received from the external application;

FIG. 25 is a diagram showing an application management table stored in an application information storing part shown in FIG. 20;

FIG. 26 is a diagram showing a first example of the communication sequence between the external application and the MFP shown in FIG. 20 when an application connection request command is issued from the external application;

FIG. 27 is a diagram showing a second example of the communication sequence between the external application and the MFP shown in FIG. 20 when the application connection request command is issued from the external application;

FIG. 28 is a diagram showing a third example of the communication sequence between the external application and the MFP shown in FIG. 20 when the application connection request command is issued from the external application;

FIG. 29 is a flow chart for explaining a process of the CPU within the controller of the MFP shown in FIG. 20 when the application connection request command is acquired from the external application;

FIG. 30 is a diagram showing a fourth example of the communication sequence between the external application and the MFP shown in FIG. 20 when the operation execution request command is issued from the external application;

FIG. 31 is a diagram showing an example of an application selecting screen displayed on the operation part shown in FIG. 20;

FIG. 32 is a diagram showing a fifth example of the communication sequence between the external application and the MFP shown in FIG. 20 when the operation execution request command is issued from the external application;

FIG. 33 is a system block diagram showing another functional structure of the important part of the MFP of the second embodiment; and

FIG. 34 is a system block diagram showing still another functional structure of the important part of the MFP of the second embodiment.

### BEST MODE FOR CARRYING OUT THE INVENTION

A description will be given of embodiments of an electronic apparatus system, an electronic apparatus therefor, a control method and a computer-readable storage medium according to the present invention, by referring to the drawings.

[First Embodiment]

First, a description will be given of a first embodiment of the electronic apparatus system according to the present invention forming an image forming system.

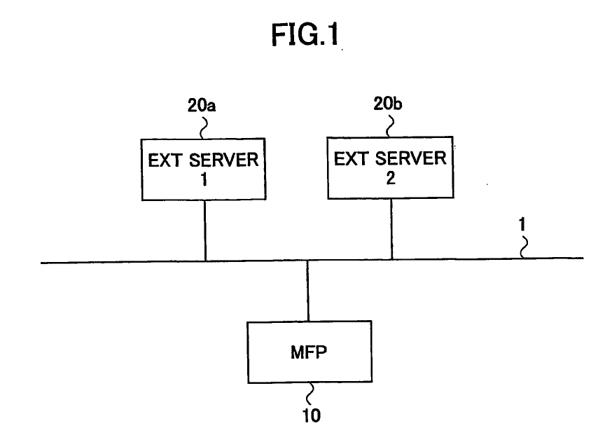

FIG. 1 is a diagram generally showing an example of a network connection of the image forming system.

The image forming system shown in FIG. 1 includes various kinds of image processing apparatuses including a digital composite apparatus (hereinafter also referred to as a Multi Function Peripheral or MFP) 10, as electronic apparatuses having a communicating function, and two external servers 20 (20a, 20b), as external apparatus, which are connected in a communicatable manner (communicatably connected) via a network 1 such as a Local Area Network (LAN). For example, the MFP 10 and the external servers 20 can communicate in a 1:N (N is an integer greater than or equal to 2) relationship (or 1.many relationship) via the network 1. But by connecting the MFP 10 and the external server 20 via a communication line such as an USB or IEEE1394 (IEEE: Institute of Electrical and Electronic Engineers), the MFP 10 and the external server 20 can communication in a 1:1 relationship. The number of external servers 20 is not limited to two, and only one or more than two external servers 20 may be provided.

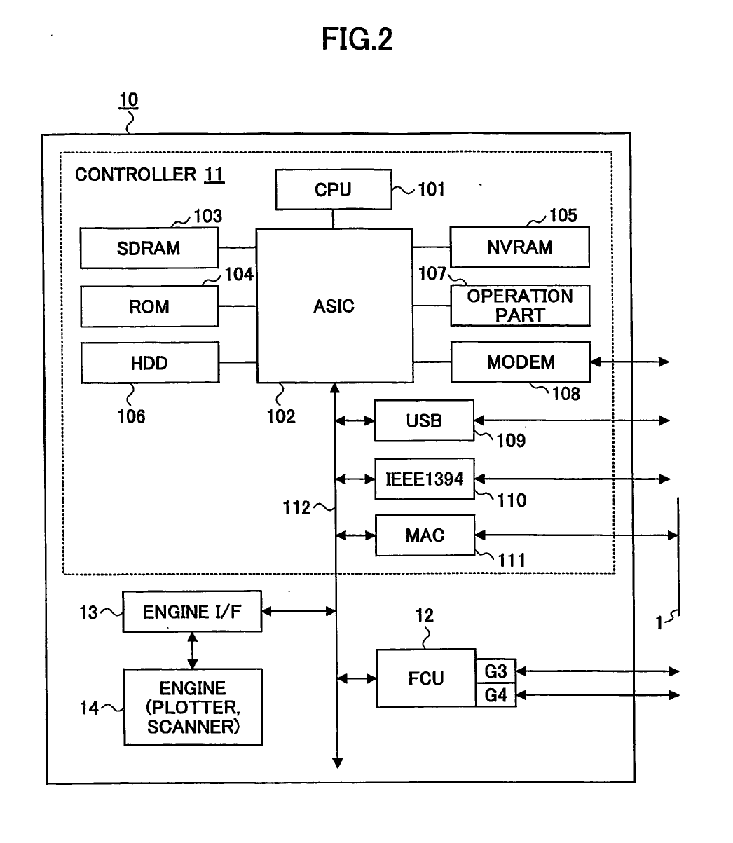

Next, a description will be given of a hardware structure of the MFP 10, by referring to FIG. 2.

FIG. 2 is a system block diagram showing the hardware structure of the MFP 10 shown in FIG. 1.

The MFP 10 shown in FIG. 2 is an image forming apparatus that can realize various kinds of functions (or facuities), including functions of a digital copying apparatus, a printer, a facsimile apparatus and a scanner apparatus, that is, a copying function, a printer function, a facsimile function and a scanner function. As shown in FIG. 2, the MFP 10 includes a controller 11, a Facsimile Control Unit (FCU) 12, an engine interface (I/F) 13, and engine 14 and the like. These elements of the MFP 10 form hardware resources for carrying out image processing such as document reading, printing (image forming) and image data transmission.

The controller 11 uses applications which will be described later, and centrally controls various parts of the MFP 10 (in response to operation requests from the applications). The various kinds of functions are realized by the control of the controller 11.

The FCU 12 controls communications between the MFP 10 and an external apparatus, such as an image forming apparatus, via a public line. The image forming apparatus may be a facsimile apparatus, a digital copying apparatus having a modem function (facsimile communication function), and other MFPs (digital composite apparatuses).

The engine I/F 13 forms an interface for connecting the engine 14 to a Peripheral Component Interconnect (PCI) bus.

The engine 14 corresponds to hardware devices such as a scanner (image reading means) for reading an image of a document (document image), a plotter (image forming means) for forming (printing) an image on a recording medium such as paper based on the image data read by the scanner or the data received from an external apparatus, an Automatic Document Feeder (ADF) for automatically feeding the document to an image reading position of the scanner, and an after-processing apparatus for carrying out an after-processing such as sorting, punching holes and stapling the recording medium that has been subjected to the image forming (printing) by the plotter.

The controller 11 includes an Application Specific Integrated Circuit (ASIC) 102, an SDRAM 103, a ROM 104, an NVRAM 105, a Hard Disk Drive (HDD) 106, an operation part 107, a modem 108, an Universal Serial Bus (USB) 109, an IEEE1394 interface (I/F) 110, a Media Access Controller interface (MAC I/F) 111, and the like. The operation part 107 is actually arranged outside the controller 11 in this embodiment.

The CPU 101 forms an operation (or computation) process means for carrying out data processing (control of various functions) via the ASIC 102.

The ASIC 102 is a multi-function device board including a CPU interface, an SDRAM interface, a local bus interface, a PCI interface, a HDD interface and the like. The ASIC 102 enables sharing of devices that are control targets of the CPU 101, and supports highly efficient development of applications and the like from the point of view of architecture.

The operation part 107 which receives operation commands and the like of the engine 14 is directly connected to the ASIC 102. The modem 108 is also directly connected to the ASIC 102. The USB I/F 109, the IEEE1394 I/F 110, the MAC I/F 111, the FCU 12 and the engine I/F 13 are connected to the ASIC 102 via the PCI bus 112.

The SDRAM 103 forms a main memory that is used as a program memory for storing various kinds of programs, a work memory used by the CPU 101 when the CPU 101 carries out the data processing, and the like. Of course, it is possible to use a DRAM or an SRAM in place of the SDRAM 103.

The ROM 104 forms a fixed memory for storing programs, including the various kinds of applications (two kinds in this particular case), and fixed data.

The NVRAM 105 forms a nonvolatile memory for storing data such as various parameters that are changeable or variable, and holds stored contents even when the power is turned OFF. Nonvolatile memories, such as a nonvolatile RAM in which a RAM and a backup circuit utilizing a battery are integrated, an EEPROM and a flash memory, may be used for the NVRAM 105.

The HDD 106 forms a storage apparatus (recording medium) for storing data regardless of whether the power is ON or OFF. The HDD 106 may also be used to store the data within the SDRAM 103 and/or the data within the NVRAM 105.

The operation part 107 forms an operation means including various kinds of operation keys (operation switches or operation buttons) for inputting information (data) such as operation commands with respect to the engine 14 or the external server 20, and a display device (or character display) such as a Liquid Crystal Display (LCD) and a Cathode Ray Tube (CRT).

The modem 108 forms a modulating and demodulating (modem) means for modulating data into a form suited for transfer on the public line when sending the data to an external apparatus (not shown) via the public line, and for demodulating the data when received from the external apparatus.

The USB I/F 109 and the IEEE1394 I/F 110 form interfaces (direct interfaces) in conformance with the USB standard and the IEEE1394 standard, respectively for making communication by directly connecting to an external apparatus (peripheral equipment).

The MAC I/F 111 forms a network interface for making communication with an external apparatus, including the external server 20, via the network 1 such as the LAN.

Of course, direct interfaces other than the USB I/F 109 and the IEEE1394 I/F 110 may be additionally provided in the controller 11.

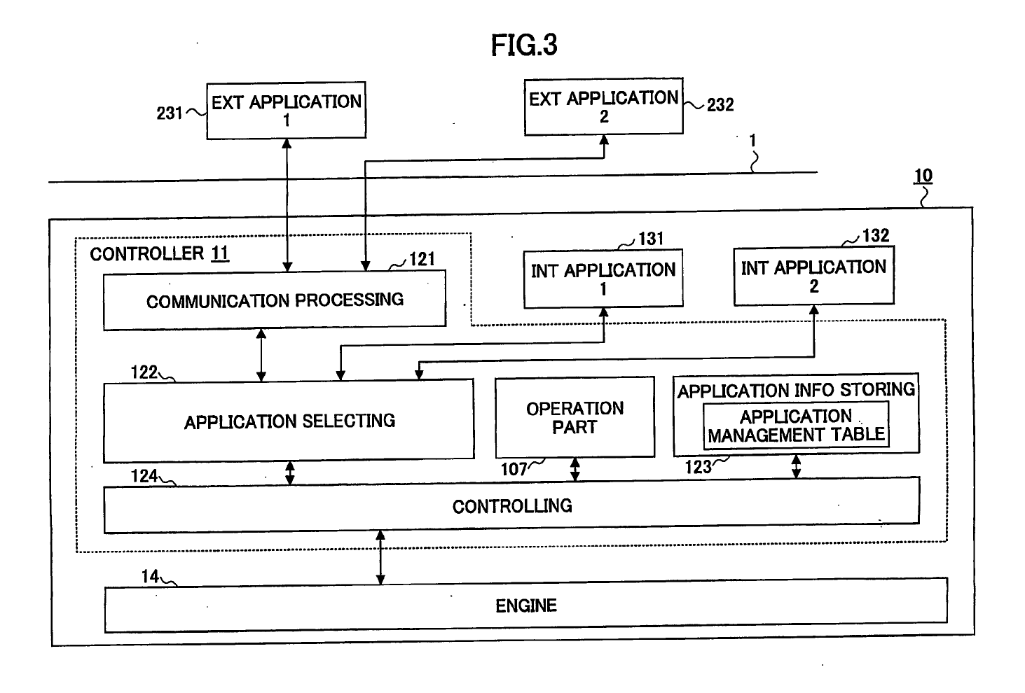

Next, a description will be given of important functional structure of the MFP 10, by referring to FIG. 3.

FIG. 3 is a system block diagram showing the functional structure of the important part of the MFP 10 shown in FIG. 1 of the first embodiment.

The controller 11 of the MFP 10 shown in FIG. 3 includes functions of a communication processing part 121, an application selecting part 122, an application information storing part 123 and a controlling part 124. These functions of the controller 11 are realized when the CPU 101 shown in FIG. 2 operates according to the programs and uses the MAC I/F 111, the USB I/F 109 and the IEEE1394 I/F 110 if necessary.

The communication processing part 121 forms a communicating means for making communication with applications (hereinafter referred to as “external applications”) 231 and 232 that are implemented in the two external servers 20 (20a, 20b) connected to the network 1, and for making communication with an external apparatus that is directly connected to the MFP 10. The external applications 231 and 232 may be directly connected to the MFP 10 to make the communication therewith.

The application selecting part 122 receives data such as the commands (operation execution requests) that are received from the applications, including the applications (hereinafter referred to as internal applications) 131 and 132 stored in the ROM 104 shown in FIG. 2 and the external applications 231 and 232, and sends (delivers) the received data to the control part 124. In addition, when data such as commands (operation instructions) are received from the control part 124, the application selecting part 122 distributes the data to the internal applications 131 and 132 and the external applications 231 and 232. In other words, the application selecting part 122 judges a sending destination (application) to which the data is to be sent, and sends the received data to this sending destination (application).

The application information storing part 123 stores information related to the applications that are usable in the MFP 10, in the form of an application management table. Hence, it is possible to register the applications that are usable in the MFP 10. The application information storing part 123 may be formed by the SDRAM 103, the NVRAM 105 or the HDD 106 shown in FIG. 2, and is changed (updated) every time the information is changed (varied). Therefore, the application information storing part 123 functions as an application information registering means.

The controlling part 124 centrally control various parts of the controller 11, including the communication processing part 121, the application selecting part 122, the operation part 107, the application information storing part 123 and the engine 14. The controlling part 124 functions as a controlling means, a device start notification sending means, a transmission permitting means (connection permitting means) and a device usability notification sending means (connection permission notification sending means).

Accordingly, the controlling part 124 can realize a large number of functions, because it is possible to use the external applications 231 and 232 in addition to the internal applications 131 and 132, by communicating with the external applications 231 and 232 via the application selecting part 122, the communication processing part 121 and the network 1.

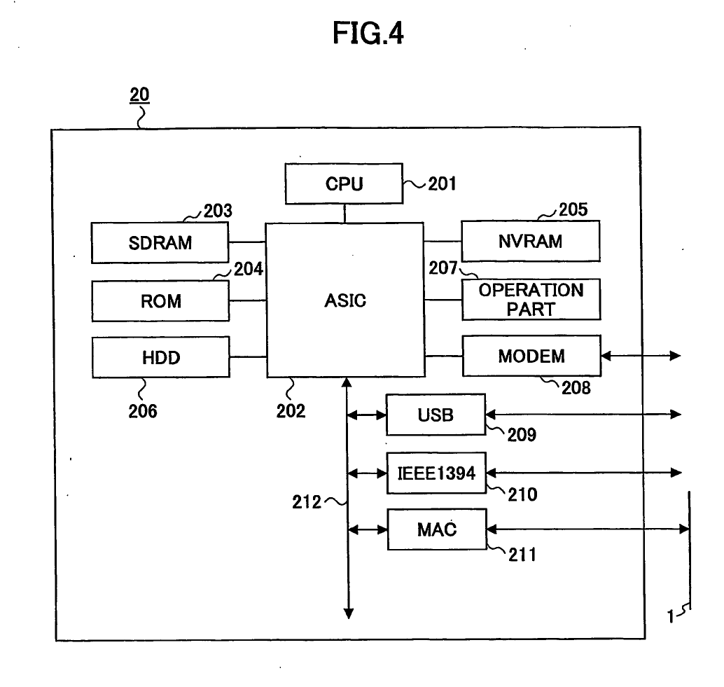

Next, a description will be given of a hardware structure of the external server 20, by referring to FIG. 4.

FIG. 4 is a system block diagram showing the hardware structure of the external server 20 shown in FIG. 1.

The external server 20 shown in FIG. 4 is formed by an information processing apparatus such as a Personal Computer (PC), and includes a CPU 201, an ASIC 202, an SDRAM 203, a ROM 204, an NVRAM 205, an HDD 206, an operation part 207, a modem 208, an USB I/F 209, an IEEE1394 I/F 210, a MAC I/F 211, a PCI bus 212 and the like.

Since the structure of the external server 20 is similar to the structure of the controller 11 described above in conjunction with FIG. 2, a description will only be given with respect to portions of the external server 20 that differ from the controller 11.

The operation part 207 includes an input device such as a keyboard and a mouse for inputting information (data) such as operation commands with respect to the MFP 10, and a display device such as an LCD and a CRT. For example, a touch panel may be provided on a surface of the display device.

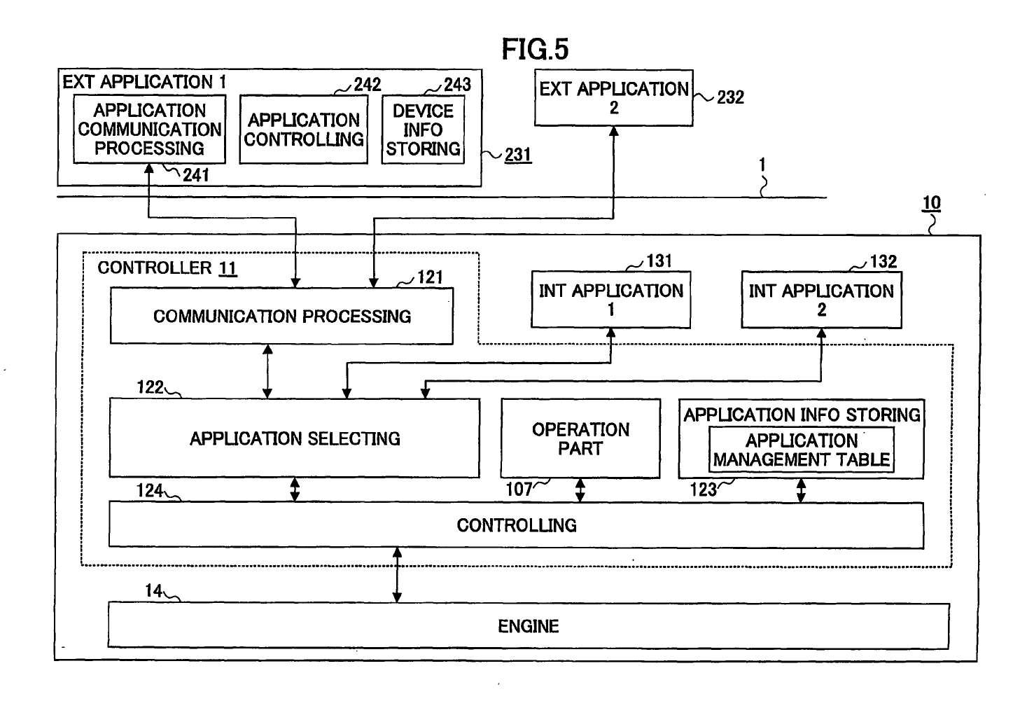

Next, a description will be given of a functional structure of an important part of the external server 20, by referring to FIG. 5.

FIG. 5 is a system block diagram showing the functional structure of the important part of the MFP 10 and the external server 20a shown in FIG. 1. For the sake of convenience, FIG. 5 shows a case where an application communication processing part 241 and the like which will be described later are provided in the external application 231.

The external server 20a includes the functions of the application communication processing part 241, an application controlling part 242 and a device information storing part 243. These functions of the external server 20a are realized when the CPU 201 shown in FIG. 4 operates according to the external application 231 stored in the ROM 104 and uses the MAC I/F 211, the USB I/F 209 and the IEEE1394 I/F 210 if necessary.

The application communication processing part 241 forms a communicating means for making communication with image processing apparatuses including the MFP 10 connected to the network 1, and for making communication with image processing apparatuses that are directly connected to the external server 20a. The application communication processing part 241 may also communicate with image processing apparatuses, such as the MFP 10, that are directly connected thereto.

The application controlling part 242 controls the application communication processing part 241 and the device information storing part 243, and functions as an application usability notification sending means, an operation execution request sending means, a connection request sending means, a function interval means and a device selecting means.

The device information storing part 243 forms an application storing means for storing information related to the image processing apparatuses that are usable by the external server 20a. Hence, it is possible to register the image processing apparatuses that are usable by the external server 20a. The device information storing part 243 may be formed by the SDRAM 203, the NVRAM 205 or the HDD 206 shown in FIG. 4, and is changed (updated) every time the information is changed (varied).

The functional structure of the important part of the other external server 20b is approximately the same as that of the external server 20a described above, and thus, a description and illustration thereof will be omitted. In addition, the processes of the applications in the external server 20 (20a, 20b), that is, the internal applications 131 and 132, are actually executed by the corresponding CPU 201 which operates according to the internal applications 131 and 132, but in the following description, it is also described for the sake of convenience as if the internal applications 131 and 132 execute the processes.

The internal applications 131 and 132 and the external applications 231 and 232 realize various kinds of functions. For example, the internal application 131 is the copy application for realizing the copy function, the internal application 132 is the printer application for realizing the printer function, the external application 231 is the scanner application for realizing the scanner function, and the external application 232 is the facsimile application for realizing the facsimile function. Of course, the internal application 131 may be an application for realizing a basic (low version) copy function and printer function, the internal application 132 may be an application for realizing a basic scanner function and facsimile function, the external application 231 may be an application for realizing a high version copy function and printer function, and the external application 232 may be an application for realizing a high version scanner function and facsimile function. In this case, the low version function has simpler/or and fewer functions than the high version function. In any case, the internal applications 131 and 132 and the external applications 231 and 232 are not limited to particular applications.

The copy function is for carrying out a copying operation that includes reading the image of the document by the scanner to obtain image data of the document, and sending the image data to the plotter to form the image data on the recording medium such as paper by the plotter.

The printer function is for carrying out a printing operation that includes sending to the plotter the image data received from the external server 20, as it is or, after processing the image data, and forming the image data on the recording medium such as paper by the plotter.

The scanner function is for carrying out a scanning operation that includes reading the image of the document by the scanner to obtain the image data, and storing the image data in the memory (SDRAM 103, the NVRAM 105 or the HDD 106).

The facsimile function is for carrying out a facsimile transmitting operation and a facsimile receiving operation. The facsimile transmitting operation includes reading the image of the document by the scanner to obtain the image data, and transmitting the image data to the external apparatus by the FCU 12. On the other hand, the facsimile receiving operation includes receiving the image data from the external apparatus by the FCU 12, and sending the image data to the plotter so as to form the image data on the recording medium such as paper.

In this first embodiment, the image processing apparatuses other than the MFP 10, such as other MFPs, printers and scanners that are not shown, are connected to the external server 20 directly or via the network 1. However, it is of course possible to similarly connect other image processing apparatuses, such as digital copying apparatuses and facsimile apparatuses, to the external server 20 directly or via the network 1. These image processing apparatuses other than the MFP 10 include a controller (not shown) having a structure similar to that of the MFP 10, and are capable of carrying out the process of the present invention described later.

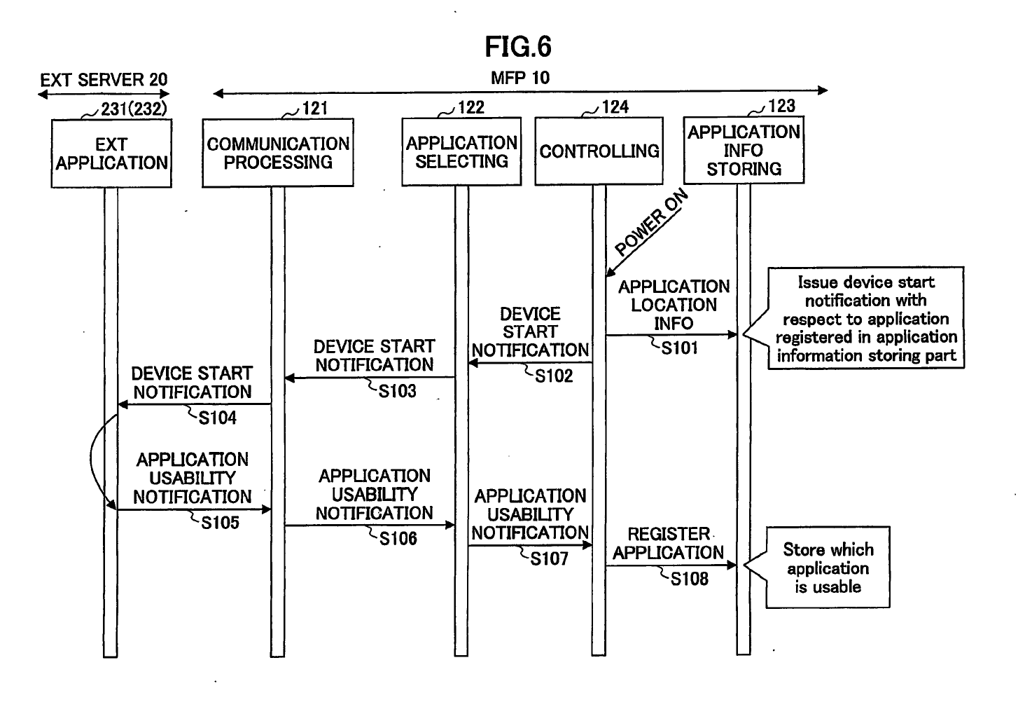

Next, a description will be given of the control (process) of the present invention in the first embodiment of the image forming system described above, by referring to FIGS. 6 through 16. For the sake of convenience, a description of the process with respect to the internal applications 131 and 132 will be omitted.

First, a description will be given of a first example (case where authentication is successful) of a communication sequence between the image processing apparatus such as the MFP 10 and the external application 231 (or 232) when the image processing apparatus is started, by referring to FIGS. 6 through 8.

FIG. 6 is a diagram showing a first example of the communication sequence between the MFP 10 shown in FIG. 3 and the external application 231 (or 232) when the MFP 10 is started.

When the MFP 10 is started (power is turned ON) the controlling part 124 of the MFP 10 issues a start notification command with respect to the usable applications that are registered in advance (indicated by the information stored in the application management table within the application information storing part 123). In other words, the start notification command is sent to the external applications 231 and 232 of the external server 20 (20a, 20b) via the application selecting part 122 and the communication processing part 121 (steps S102 through S104). The start notification commands with respect to the external applications 231 and 232 are respectively added with an application identification number for identifying the external applications 231 and 232, and this application identification number may be acquired from the application information storing part 123 shown in FIG. 3 together with information indicating the application implemented locations (step S101).

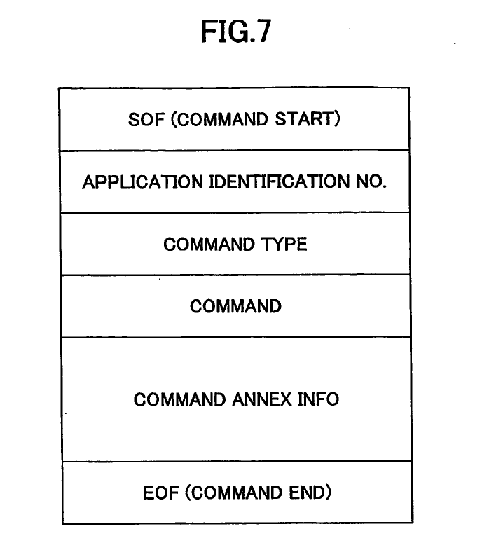

A description will be given of a structure of commands exchanged between the MFP 10 and the external applications 231 and 232 of the external server 20 (20a, 20b) by referring to FIG. 7.

FIG. 7 is a diagram showing the structure of the command exchanged between the MFP 10 shown in FIG. 3 and the external applications 231 and 232.

The command shown in FIG. 7 includes application identification information, command type, command (main body of command), command annex information, and tags (SOF, EOF) indicating the start and end of the command.

The application identification information is related to the application, and is for identifying the application.

The command type is information related to the command, and is for indicating the type of various commands such as commands that control the plotter and commands that control the scanner.

The command annex information indicates parameters used when executing the command. For example, in the case of a command related to the scanner, the parameters used when executing this command include information related to a main scan length, a sub scan length, a reading density and the like.

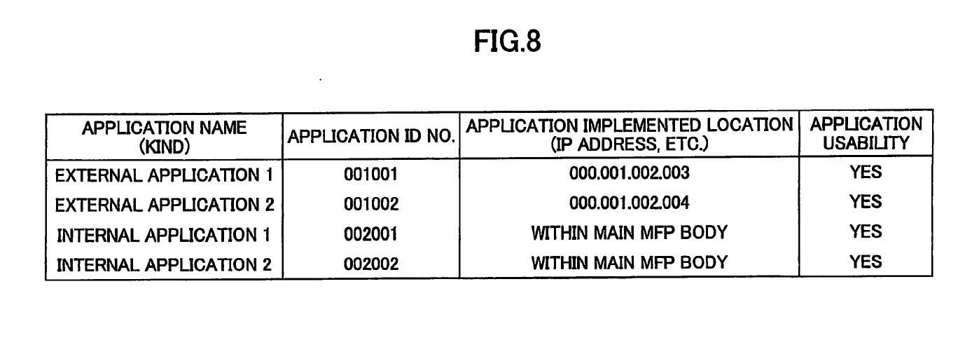

Next, a description will be given of the application management table (information related to the applications), including the application identification numbers, stored in the application information storing part 123 shown in FIG. 3, by referring to FIG. 8. FIG. 8 is a diagram showing contents of the application management table.

As shown in FIG. 8, the application management table includes, for each of the applications (internal applications 131 and 132, external applications 231 and 232), an application name (kind), an application identification number (application ID No.), an application implemented location (IP address, etc.), and information (application usability) indicating whether or not the application is usable.

Returning now to the description of FIG. 6, if the external servers 20a and 20b have been started and the external applications 231 and 232 receive the start notification command (device start notification command) from the MFP 10, the external applications 231 and 232 make a response by issuing the application usability notification command thereof with respect to the MFP 10 (step S105). The application usability notification command with respect to the MFP 10 is added with the application identification number that is added to the device start notification command described above, and thus, the MFP 10 can identify from this application identification number the application from which the application usability notification command is received.

The application usability notification command issued from the external application 231 or 232 is sent to the MFP 10 via the network 1, and is further sent to the controlling part 124 via the communication processing part 121 and the application selecting part 122 within this MFP 10 (steps S105 through S107).

When the application usability notification command is received by the controlling part 124, the controlling part 124 can judge the application usability from the application identification information that is added to the application usability notification command. Hence, by setting the corresponding information (application usability) indicating whether or not the application is usable to “YES” in the application management table stored within the application information storing part 123, the controlling part 124 can register the usable application (step S108). An application that is not registered in advance in the application information storing part 123 is not regarded as being usable.

In addition, the application usability notification command is not received from the external application of the external server whose power is not turned ON, and thus, the controlling part 124 sets the corresponding information (application usability) indicating whether or not the application is usable to “NO” in the application management table stored within the application information storing part 123.

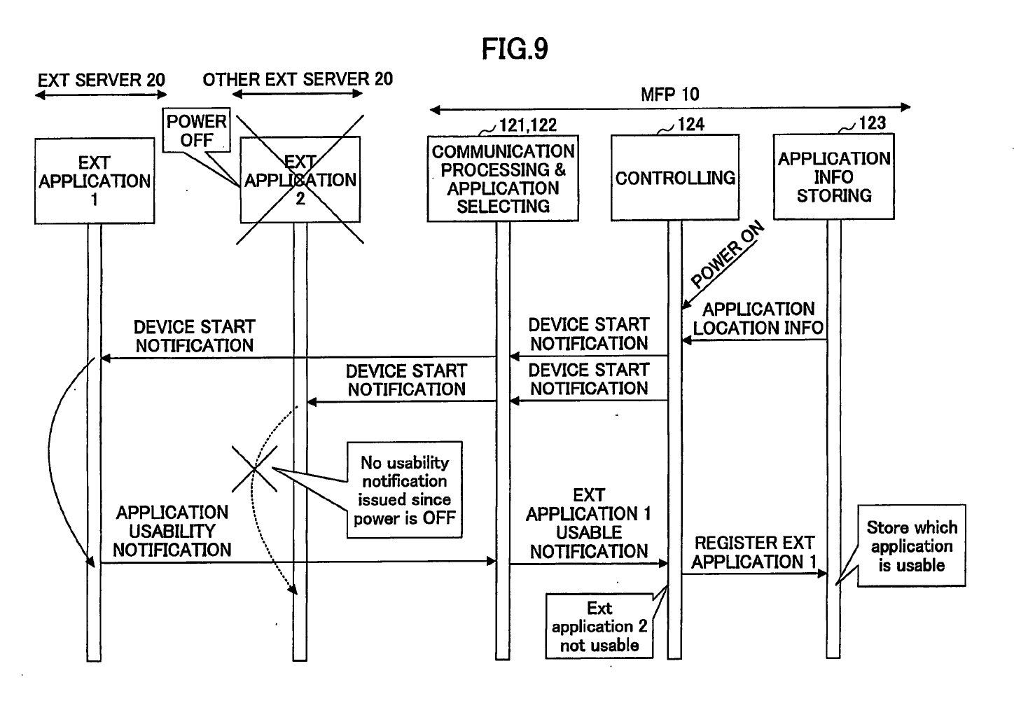

FIG. 9 shows the communication sequence for this case.

More particularly, FIG. 9 is a diagram showing a second example of the communication sequence between the MFP 10 shown in FIG. 3 and the external application when the MFP 10 is started, in order to enable execution of the application operation. As described above in conjunction with FIG. 6, the command is actually sent from the controlling part 124 to the application selecting part 122 and then to the communication processing part 121. But since the application selecting part 122 and the communication processing part 121 simply follow the instruction from the controlling part 124, the application selecting part 122 and the communication processing part 121 are illustrated as a single block in FIG. 9 for the sake of convenience.

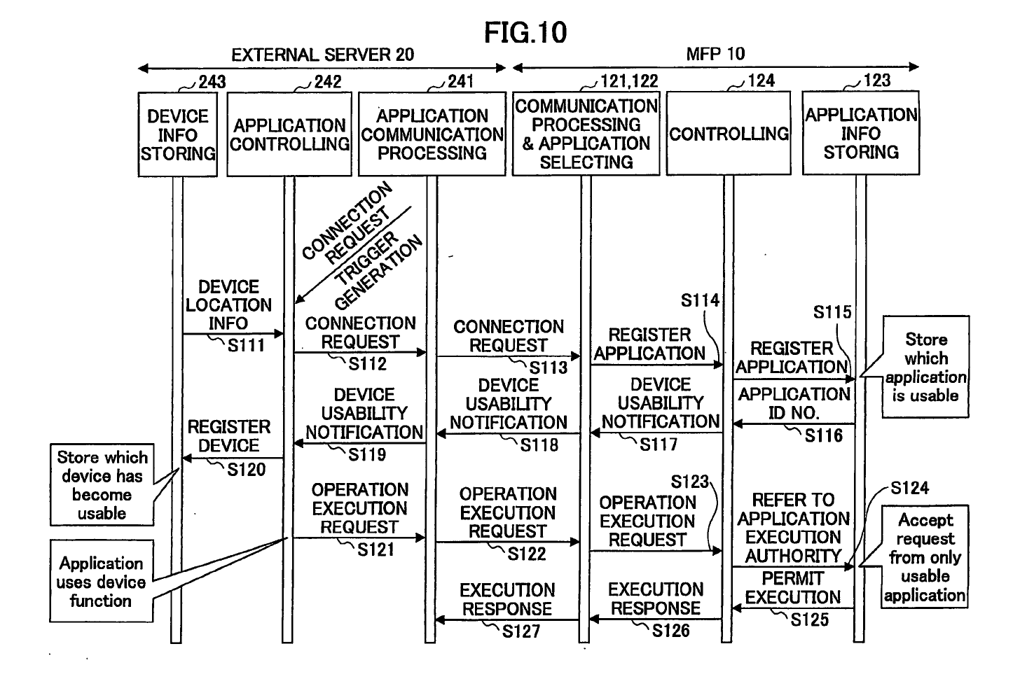

Next, a description will be given of first and second examples of the communication sequence between the external application 231 (or 232) and the image processing apparatus such as the MFP 10, when an application connection request command (connection request) is issued from the external application 231 (or 232), by referring to FIGS. 10 through 12.

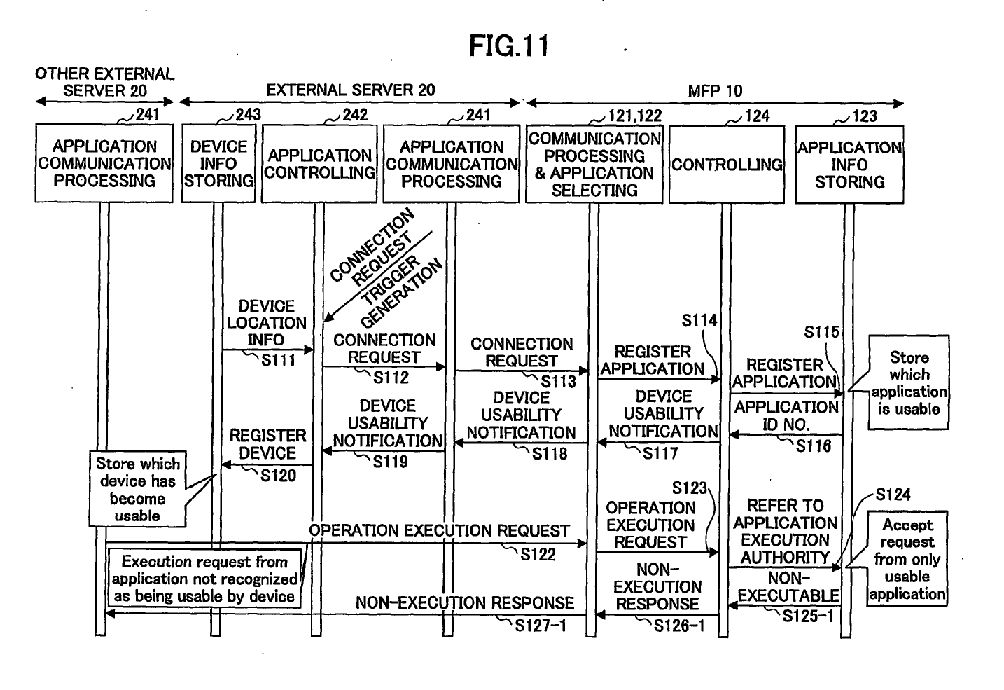

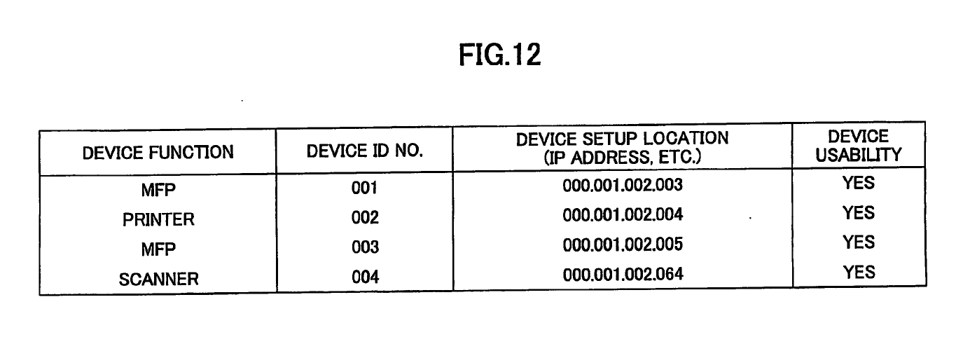

FIG. 10 is a diagram showing the first example (case where requested application operation is executable) of the communication sequence between the external application 231 (or 232) and the MFP 10 shown in FIG. 3 when the application connection request command is issued from the external application 231 (or 232). FIG. 11 is a diagram showing the second example (case where requested application operation is non-executable) of the communication sequence between the external application 231 (or 232) and the MFP 10 shown in FIG. 3 when the application connection request command is issued from the external application 231 (or 232). As described above in conjunction with FIG. 6, the command is actually sent from the controlling part 124 to the application selecting part 122 and then to the communication processing part 121. But since the application selecting part 122 and the communication processing part 121 simply follow the instruction from the controlling part 124, the application selecting part 122 and the communication processing part 121 are illustrated as a single block in FIGS. 10 and 11 for the sake of convenience. FIG. 12 is a diagram for explaining information (device unique information) related to the image processing apparatus, including a device identification number stored in the device information storing part 243 shown in FIG. 5.

The application controlling part 242 of the external application 231 issues the application connection request command with respect to each of the image processing apparatuses (indicated by the information stored in the device information storing part 243), including the MFP 10, that are registered in advance, when some kind of a trigger is generated for making a connection to the image processing apparatus. For example, the trigger may be a time when the external application 231 is started or, when an input operation is thereafter made by the user from the operation part 207 shown in FIG. 4 to use the initial function of the image processing apparatus. In other words, the application connection request command is sent by the application communication processing part 241 to each of the image processing apparatuses (steps S112 and S113). The device identification number for identifying the image processing apparatus is added to the application connection request command, and this device identification number is acquired from the device information storing part 243 shown in FIG. 5 together with the information indicating a device setup location of the image processing apparatus (step Sill).

For example, the trigger described above includes a case (a) where the external application 231 is started by the turning ON of the power of the external server 20 (20a), and a case (b) where the input operation is made by the user from the operation part 207 after the external application 231 is started by the turning ON of the power of the external server 20 to use the initial function of the image processing apparatus (in a state where no connection has been made with the image processing apparatus).

A description will be given of the information (device unique information) related to the image processing apparatus, including the device identification number, stored in the device information storing part 243 shown in FIG. 5, by referring to FIG. 12.

As shown in FIG. 12, the device information storing part 243 stores, as the device unique information, the device identification number of each image processing apparatus, the device setup location, and information (device usability) indicating whether or not the device is usable, for each type of image processing apparatus.

Returning now to the description of FIG. 10, when the application connection request command from the external application 231 is received via the communication processing part 121, the application selecting part 122 of the MFP 10 judges the external application 231 which issued this application connection request, and sends a registration command instructing the registration of this external application 231 to the controlling part 124 by adding information related to the external application 231 such as the application implemented location (IP address, etc.) of the external application 231 (step S114).

When the registration command is received, the controlling part 124 writes the information that is related to the external application 231 and is added to the received registration command into a vacant application identification information area of the application management table stored in the application information storing part 123 (writes “YES” in the corresponding information (application usability) indicating whether or not the application is usable), so as to register the usable external application 231 (step S115). An application that is not registered in advance in the application information storing part 123 is not regarded as being usable.

When the writing (registration) to the vacant application identification information area of the application management able is completed, the application information storing part 123 makes a response by sending this application identification information to the controlling part 124 (step S116).

When the response including the application identification information is received from the application information storing part 123, the controlling part 124 issues a device usability notification command of the MFP 10 with respect to the external application 231. In other words, the device usability notification command is sent to the external application 231 via the application selecting part 122 and the communication processing part 121 (steps S117 and S118). The device usability notification command with respect to the external application 231 is added with the device identification number that is added to the application connection request command that has been received from the external application 231, so that the external application 231 can identify the MFP 10 from the device identification number.

When the device usability notification command from the MFP 10 is received via the application communication processing part 241, the application controlling part 242 of the external application 231 can judge the usability of the MFP 10 from the device identification information that is added to this device usability notification command. Hence, the application controlling part 242 of the external application 231 writes “YES” in the corresponding information (device usability) indicating whether or not the device is usable), so as to register the usable MFP 10 (steps S119 and S120).

When an image processing apparatus other than the MFP 10 receives the application connection request command from the external application 231, this image processing apparatus may carry out the process similarly to the MFP 10 described above.

Thereafter, when a function (for example, the scanner function) of the usable image processing apparatus such as the MFP 10 is to be used, the application controlling part 242 of the external application 231 issues a corresponding operation execution request command with respect to the MFP 10 (step S121).

The operation execution request command issued from the external application 231 is sent to the MFP 10, and is further sent to the controlling part 124 via the communication processing part 121 and the application selecting part 122 within the MFP 10 (steps S122 and S123).

When the operation execution request command is received, the controlling part 124 sends an instruction to the application information storing part 123 to make a reference to an execution authority of the application operation requested by this operation execution request command, together with the information related to the external application 231 added to this operation execution request command (step S124). Only the operation execution request command from the usable application is accepted.

In response to this instruction from the controlling part 124, the application information storing part 123 refers to the execution authority (corresponding application usability) of the application operation requested by the operation execution request command within the application management table, based on the information related to the external application 231. If the requested application operation is executable (corresponding application usability is “YES”), the application information storing part 123 sends a response indicating the executability of the requested application operation to the controlling part 124 (step S125).

When the response from the application information storing part 123 is received, the controlling part 124 executes the application operation (an image processing operation such as the copy operation, printer operation, scanner operation, facsimile transmitting operation and facsimile receiving operation or, a portion of such an image processing operation) requested by the operation execution request command that has been received, and issues a command (execution response command) for sending a response indicating the result of executing the application operation with respect to the external application 231. In other words, the execution response command from the controlling part 124 is sent to the external application 231 via the application selecting part 122 and the communication processing part 121 (steps S126 and S127).

On the other hand, suppose that the operation execution request command from the external application 232 (application not recognized as being usable) is sent to the MFP 10, and this operation execution request command is set to the controlling part 124 via the communication processing part 121 and the application selecting part 122 within the MFP 10 (steps S122 and S123), as shown in FIG. 11. In FIG. 11, those steps that are the same as those corresponding steps in FIG. 10 are designated by the same reference numerals, and a description thereof will be omitted. In this case, the controlling part 124 and the application information storing part 123 carry out the following process.

When the operation execution request command from the external application 232 is received, the controlling part 124 sends an instruction to the application information storing part 123 to make a reference to the execution authority of the application operation requested by this operation execution request command, together with the information related to the external application 232 added to this operation execution request command (step S124). Only the operation execution request command from the usable application is accepted.

In response to this instruction from the controlling part 124, the application information storing part 123 refers to the execution authority (corresponding application usability) of the application operation requested by the operation execution request command within the application management table, based on the information related to the external application 232. If the requested application operation is non-executable (corresponding application usability is “NO”), the application information storing part 123 sends a response indicating the non-executability of the requested application operation to the controlling part 124 (step S125-1).

When the response from the application information storing part 123 is received, the controlling part 124 does not execute the application operation requested by the operation execution request command that has been received, and issues a command (non-execution response command) for sending a response indicating the result of not executing the application operation with respect to the external application 232. In other words, the non-execution response command from the controlling part 124 is sent to the external application 232 via the application selecting part 122 and the communication processing part 121 (steps S126-1 and S127-1).

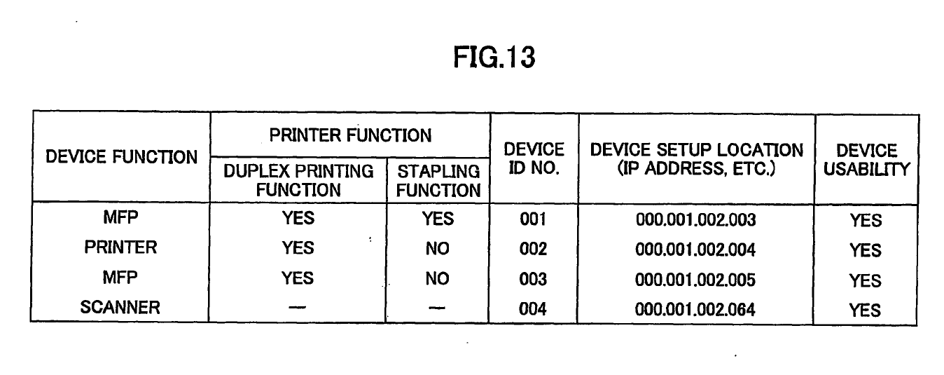

For example, it is possible to store more detailed information shown in FIG. 13 in the device information storing part 243 shown in FIG. 5, as the device unique information (information related to the image processing apparatus).

FIG. 13 is a diagram for explaining more detailed information related to the image processing apparatus stored in the device information storing part 243 shown in FIG. 5. As shown in FIG. 13, the device unique information additionally includes information related to the existence of a duplex printing function and a stapling function for each image processing apparatus, in addition to the device unique information shown in FIG. 12.

When the device unique information shown in FIG. 13 is to be stored in the device information storing part 243 within the external application 231 (or 232), the device unique information may be stored by (1) storing the detailed information in the device information storing part 243 of the external application 231 for each image processing apparatus or, (2) inquiring the existence of the function to be used to each image processing apparatus when the external application 231 uses the detailed information related to each image processing apparatus, for example.

In the case (1), the processing time is short because there is no inquiring process. However, it is necessary to provide a storage capacity in the external application 231 for storing the detailed information related to each image processing apparatus. On the other hand, in the case (2), the processing time is longer compared to that of the case (1), but it is unnecessary to store the detailed information related to each image processing apparatus in the external application 231.

In the case (1), the detailed information shown in FIG. 13 is stored in the device information storing part 243 as the device unique information (information related to each image processing apparatus). Such device unique information may be obtained by the external application 231 by the following method (1-a) or (1-b), for example.

According to the method (1-a), the external application 231 knows the device unique information in advance, similarly to the device setup location.

According to the method (1-b), when the external application 231 sends a connection request notification command to the MFP 10 (or another image processing apparatus) the MFP 10 (or the other image processing apparatus) sends a device usability notification command thereof to the external application 231, as a response with respect to the connection request notification command, by adding the detailed information thereof to the device usability notification command. When the device usability notification command from the MFP 10 (or the other image processing apparatus) is received, the external application 231 writes “YES” to the existence of the corresponding duplex printing function and stapling function and writes “YES” to the device usability within the device information storing part 243, so as to register the usable MFP 10 (or the other image processing apparatus) in a manner similar to that shown in FIG. 10.

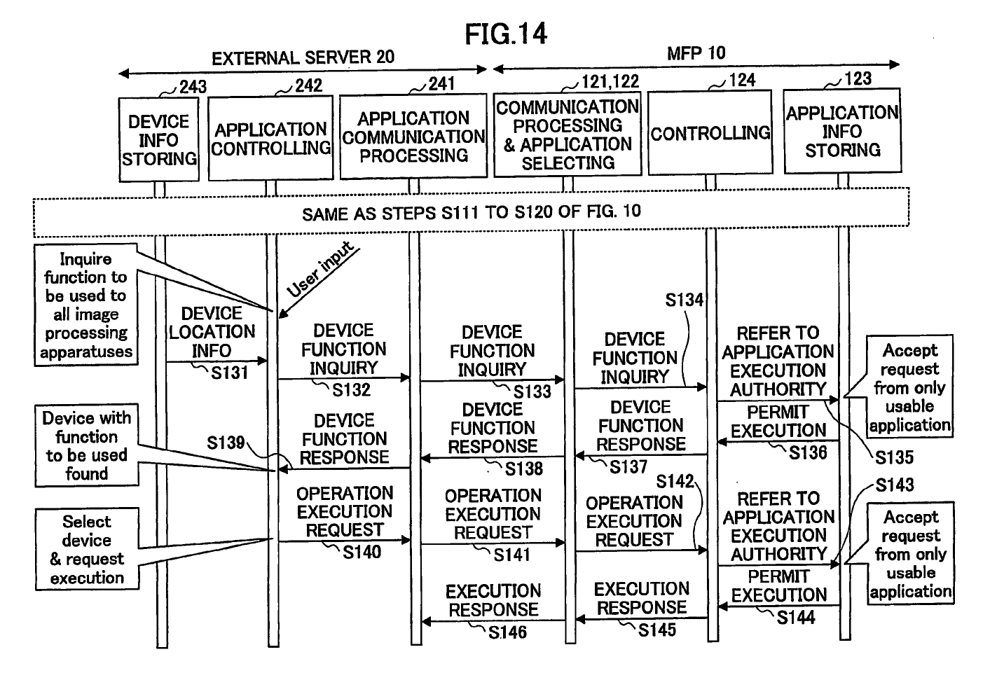

On the other hand, in the case (2), after the external application 231 and each image processing apparatus (indicated by the information stored in the device information storing part 243) carry out the communication process (process sequence) described above in conjunction with FIG. 10, the external application 231 sends a function inquiry command which inquires the existence of the function (desired function the user desires to use) to be used, with respect to all usable image processing apparatuses. The communication process subsequent to this process (function inquiry process) of sending the function inquiry command becomes as shown in FIG. 14, for example.

A description will now be given of the communication process between the external application 231 and each image processing apparatus when the external application 231, forming a function inquiring means, inquires the existence of the function to each image processing apparatus, by referring to FIGS. 14 through 17.

FIG. 14 is a diagram showing a third example of the communication sequence between the external application 231 (or 232) and the MFP 10 shown in FIG. 3 when the application connection request command is issued from the external application 231 (or 232). As described above in conjunction with FIG. 6, the command is actually sent from the controlling part 124 to the application selecting part 122 and then to the communication processing part 121. But since the application selecting part 122 and the communication processing part 121 simply follow the instruction from the controlling part 124, the application selecting part 122 and the communication processing part 121 are illustrated as a single block in FIG. 14 for the sake of convenience.

The application controlling part 242 of the external application 231 carries out the communication process described above in conjunction with FIG. 10 with each image processing apparatus, including the MFP 10, and registers the usable image processing apparatus (including MFP 10). When an input operation is thereafter made by the user from the operation part 207 to use the function of the image processing apparatus (in this particular case, when the user specifies the desired function the user desires to use), the application controlling part 242 issues a device function inquiry command to inquire the existence of the function to be used (desired function) with respect to each usable image processing apparatus. In other words, the device function inquiry command is sent to each image processing apparatus via the application communication processing part 241 (steps S132 and S133). The device function inquiry command is added with the device identification number for identifying the image processing apparatus. This device identification number is acquired from the device information storing part 243 shown in FIG. 5 together with the device setup location (step S131).

When the device function inquiry command is received via the communication processing part 121 and the application selecting part 122 (step S134), the controlling part 124 of the MFP 10 sends an instruction to the application information storing part 123 to make a reference to the execution authority of the application operation requested by the operation execution request command from the external application 231, together with the information related to the external application 231 added to this device function inquiry command (step S135). Only the operation execution request command from the usable application is accepted.

In response to this instruction from the controlling part 124, the application information storing part 123 refers to the execution authority of the application operation requested by the operation execution request command within the application management table, based on the information related to the external application 231. If the requested application operation is executable (corresponding application usability is “YES”), the application information storing part 123 sends a response indicating the executability of the requested application operation to the controlling part 124 (step S136). On the other hand, if the requested application operation is non-executable (corresponding application usability is “NO”), the application information storing part 123 sends a response indicating the non-executability of the requested application operation to the controlling part 124.

When the response from the application information storing part 123 indicating the executability of the requested application operation is received, the controlling part 124 checks the existence of the function specified by the device function inquiry command that has been received, and issues a command (device function response command) for sending a response indicating the result of checking the function with respect to the external application 231. In other words, the device function response command from the controlling part 124 is sent to the external application 231 via the application selecting part 122 and the communication processing part 121 (steps S137 and S138). The device identification information added to the device function inquiry command that has been received from the external application 231 is added to the device function response command that is sent to the external application 231.

On the other hand, when the response from the application information storing part 123 indicating the non-executability of the requested application operation is received, the controlling part 124 issues a command (non-executable response command) indicating that the requested application operation cannot be executed, with respect to the external application 231.

When an image processing apparatus other than the MFP 10 receives the device function inquiry command from the external application 231, this image processing apparatus may carry out the process similarly to the MFP 10 described above.

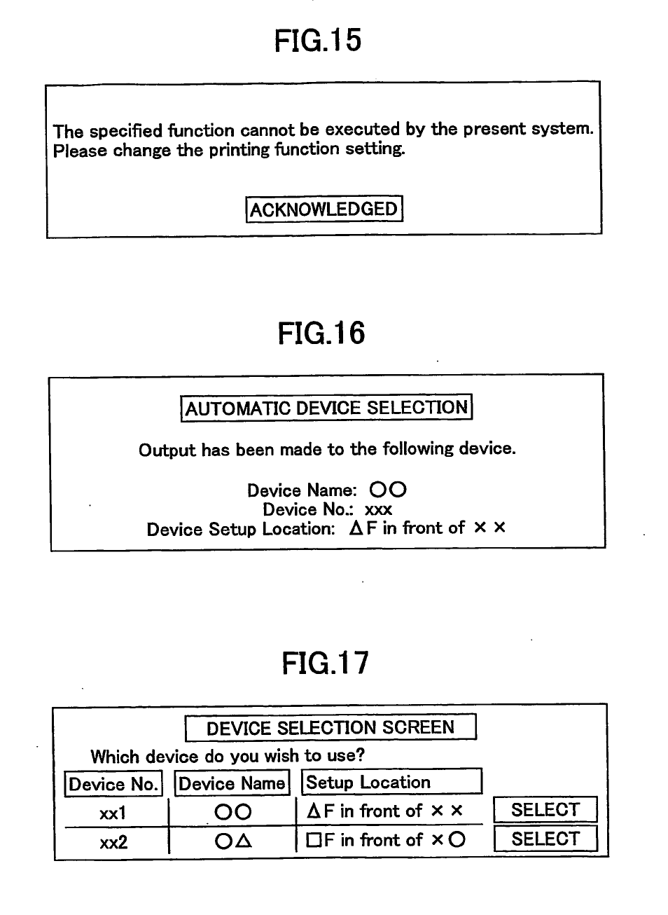

The application controlling part 242 of the external application 231 receives the device function response command from each of the image processing apparatuses, including the MFP 10, via the application communication processing part 241 (step S139). If it is recognized from the device function response command that no image processing apparatus having the function (desired function the user desired to use) specified by the input operation of the operation part 207 has been found, a warning screen shown in FIG. 15, for example, is displayed on the operation part 207 (display device) shown in FIG. 4, so as to notify the user that the specified function cannot be used and to urge the user to specify another function (change the function setting). FIG. 15 is a diagram showing an example of the warning screen displayed on the operation part 207 shown in FIG. 4.

On the other hand, if it is recognized from the device function response command that image processing apparatuses having the function (desired function the user desired to use) specified by the input operation of the operation part 207 have been found, a process is carried out to select the image processing apparatus.

The process of selecting the image processing apparatus may be carried out by a method (A) or a method (B) for example.

According to the method (A), the image processing apparatus (searched image processing apparatus) having the function specified by the operation of the operation part 207 is automatically selected, and the image processing apparatus which is selected and used is notified to the user.

According to the method (B), a list of information related to the searched image processing apparatuses is displayed on the operation part 207, so as to urge the user to select the image processing apparatus.

When a plurality of image processing apparatuses having the specified function are found, the automatic selection of the image processing apparatus according to the method (A) may be made depending on the order in which the image processing apparatuses are found, the order of the closeness of the location of the image processing apparatuses found relative to the external application 231 or, the order of the fastness of printing speed (image forming speed) of the image processing apparatuses found, for example. In this case, the application controlling part 242 of the external application 231 needs to additionally know the physical locations, the printing speeds and the like of the image processing apparatuses, similarly to the other device information (information related to the image processing apparatuses). The image processing apparatus which is automatically selected and used may be notified to the user by displaying a screen shown in FIG. 16 on the operation part 207, for example. FIG. 16 is a diagram showing an example of the screen for notifying the image processing apparatus used by the external application 241 shown in FIG. 3 to the user.

A screen shown in FIG. 17, for example, may be displayed on the operation part 207 when displaying the list of information related to the searched image processing apparatuses to urge the user to make a selection. FIG. 17 is a diagram showing an example of the screen displaying the list of information related to the image processing apparatuses connected to the network.

After the process of selecting the image processing apparatus having the specified function (defied function the user desires to use), the application controlling part 242 of the external application 231 issues a corresponding operation execution request command with respect to the selected image processing apparatus, so as to use (realize) the specified function (step S140). The communication sequence of subsequent steps S141 through S146 are the same as the communication sequence of the steps S122 through S127 shown in FIG. 10, and a description thereof will be omitted.

The search for the image processing apparatuses having the specified function is made based on the device unique information shown in FIG. 13 within the device information storing part 243 in the case (1) described above. On the other hand, the search for the image processing apparatuses having the specified function is made by sending the function inquiry command which inquires the existence of the specified function to all usable image processing apparatuses in the case (2) described above.

Therefore, according to the image fo_cming system of the first embodiment, each of the image processing apparatuses, including the MFP 10, communicates with the external application, and executes an operation using the external application. Consequently, the following effects can be obtained. In other words, since a common application can be used in common among a plurality of image processing apparatuses, each image processing apparatus can be produced at a low cost but can realize a plurality of functions. In addition, it is possible to reduce the operation of updating versions of the applications (functions). Furthermore, it is possible to improve the degree of freedom of designing the image processing apparatus, because it is possible to also use the internal applications as they are without having to make modifications.

Each of the image processing apparatuses, including the MFP 10, can also obtain the following effects by enabling the process described above in conjunction with FIG. 6 (process of using the external application 231 or 232 by communicatably connecting the image processing apparatus to the external application 231 or 232 by the start notification of the image processing apparatus) and the communication process (process of using the external application 231 or 232 by communicatably connecting the image processing apparatus to the external application 231 or 232 by the connection request from the external application 231 or 232) described above in conjunction with FIG. 10 or 14 to be selectively executed.

In other words, it is possible to increase combinations of constituent elements of the system, and the degree of freedom of combining the constituent elements of the system improves. In addition, even in a case where the image processing apparatus cannot be communicatably connected to the external application 231 or 232 by the communication process described above in conjunction with FIG. 6 (a case where the power of the external server 20 including the external application 231 or 232 is not ON or a case where the network connection is impossible), the image processing apparatus can still be communicatably connected to the external application 231 or 232 by the communication process described above in conjunction with FIG. 10 or 14. As a result, it is possible to reduce the possibility of not being able to execute an operation using the external application 231 or 232, and the reliability of the system improves.

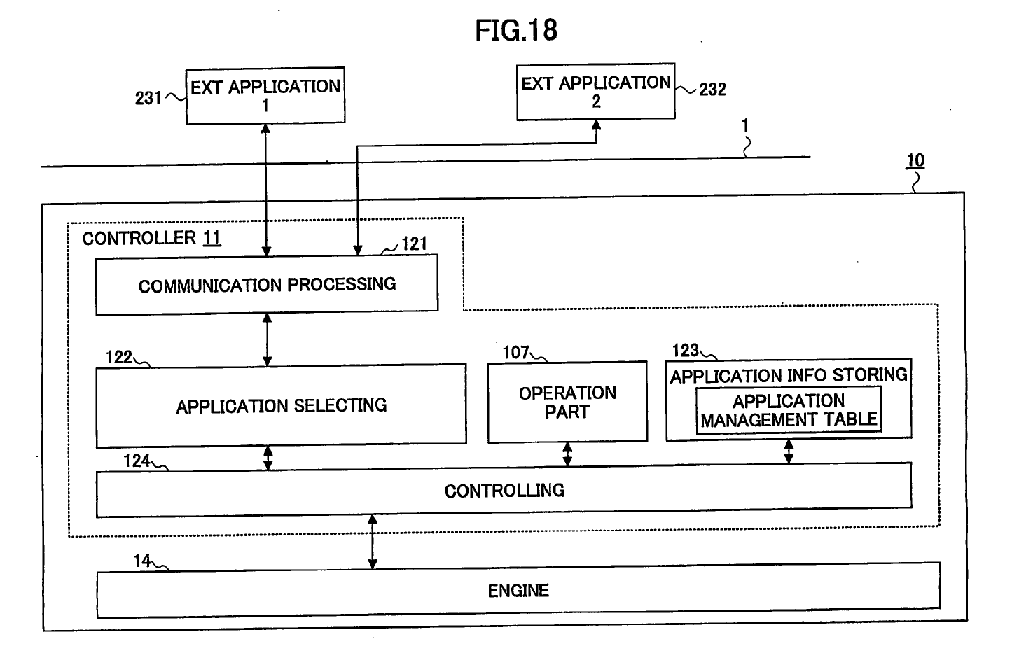

In addition, the MFP 10 may not be implemented with the internal applications in the controller 11, and execute the application operation using only the external application or applications, as shown in FIG. 18, for example. FIG. 18 is a system block diagram showing another functional structure of the important part of the MFP 10 shown in FIG. 1. In FIG. 18, those parts that are the same as those corresponding parts in FIG. 3 are designated by the same reference numerals, and a description thereof will be omitted. Of course, other image processing apparatuses may have a functional structure similar to that of the MFP 10 shown in FIG. 18.

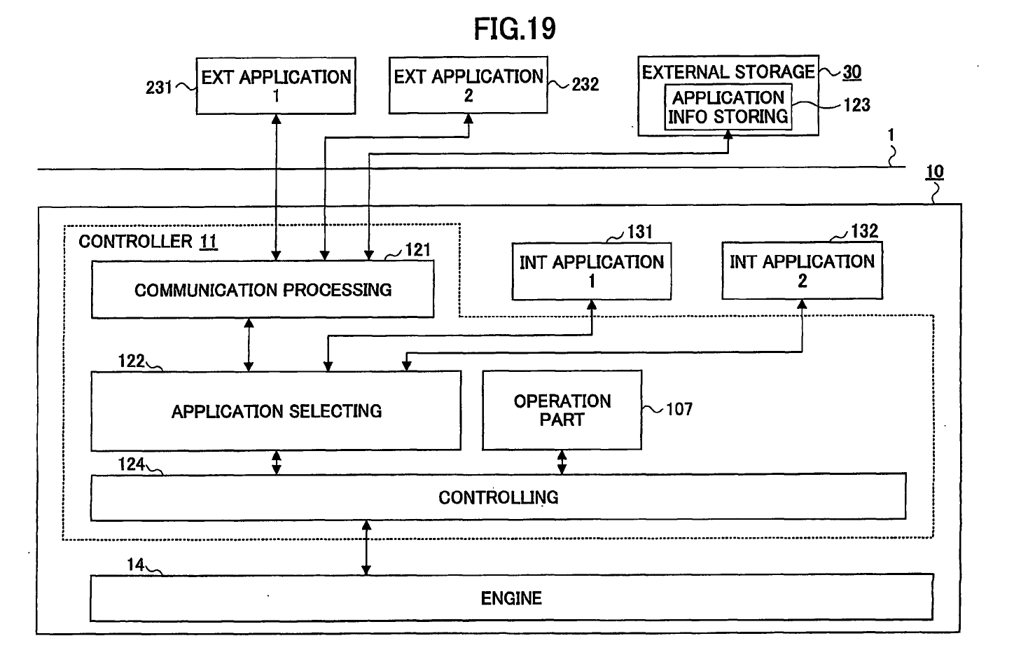

Moreover, the MFP 10 may not be provided with the application information storing part 123 in the controller 11, and the application information storing part 123 may be provided in an external storage apparatus 30 that is connected to the MFP 10 via the network 1, as shown in FIG. 19, for example. FIG. 19 is a system block diagram showing still another functional structure of the important part of the MFP 10 shown in FIG. 1. In FIG. 19, those parts that are the same as those corresponding parts in FIG. 3 are designated by the same reference numerals, and a description thereof will be omitted. In this case, the MFP 10 can make access to the application information storing part 123 by communicating with the external storage apparatus 30, and write or read (acquire) the information related to the internal applications and the external applications. Of course, other image processing apparatuses may have a functional structure similar to that of the MFP 10 shown in FIG. 19.

In addition, the MFP 10 may use the external application 231 or 232 by communicatably connecting to the external application 231 or 232 via other interfaces such as the USB I/F 109 and the IEEE1394 I/F 110. Of course, other image processing apparatuses may be communicatable connected to the external application 231 or 232 in a similar manner.

[Second Embodiment]

Next, a description will be given of a second embodiment of the electronic apparatus system according to the present invention forming the image forming system. The connection relationships of the image processing apparatuses, including the MFP, and the external servers, which form the image forming system, and the hardware structures thereof, are the same as those described above in conjunction with FIGS. 1, 2 and 4, and a description and illustration thereof will be omitted.

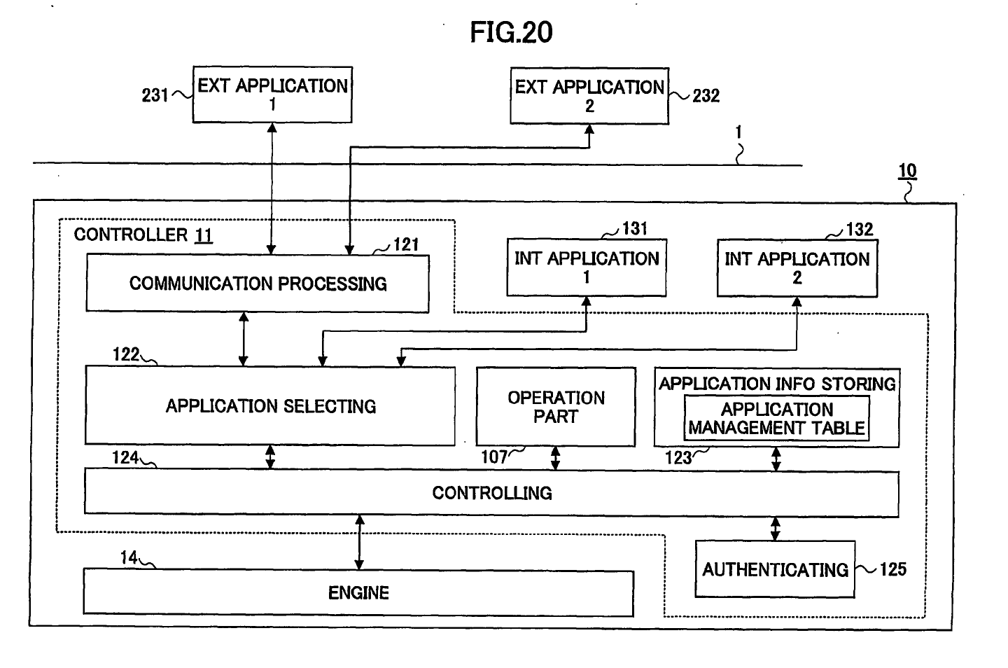

First, a description will be given of a functional structure of an important part of the MFP 10, by referring to FIG. 20.

FIG. 20 is a system block diagram showing the functional structure of the important part of the MFP 10 of the second embodiment. In FIG. 20, those parts that are the same as those corresponding parts in FIG. 3 are designated by the same reference numerals, and a description thereof will be omitted.

In the MFP 10, an authenticating part 125 forms an authenticating means (first authenticating means, second authenticating means) for carrying out an authentication process to confirm the validity of an operation execution request command when the operation execution request command is received from the external application 231 via the communication processing part 121, the application selecting part 122 and the controlling part 124. The function of the authenticating part 125 is realized by the CPU 101 shown in FIG. 2 which carries out an operation according to the program stored in the ROM 104.

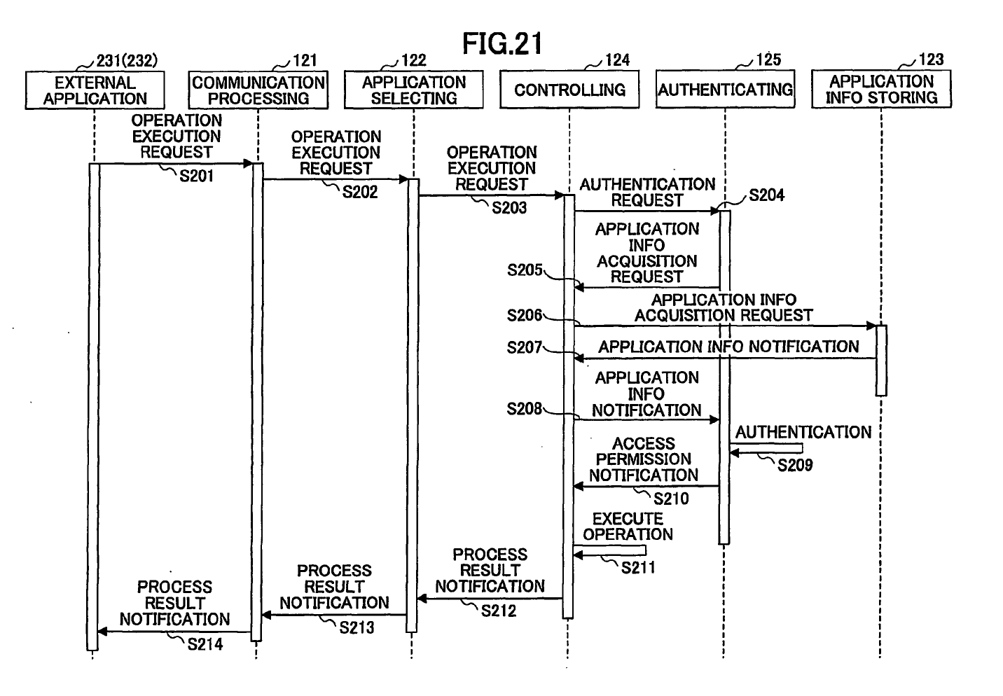

Next, a description will be given of the control in this second embodiment of the image forming system, by referring to FIGS. 21 through 32. For the sake of convenience, the process with respect to the internal applications 131 and 132 will be omitted.

### FIRST CONTROL EXAMPLE

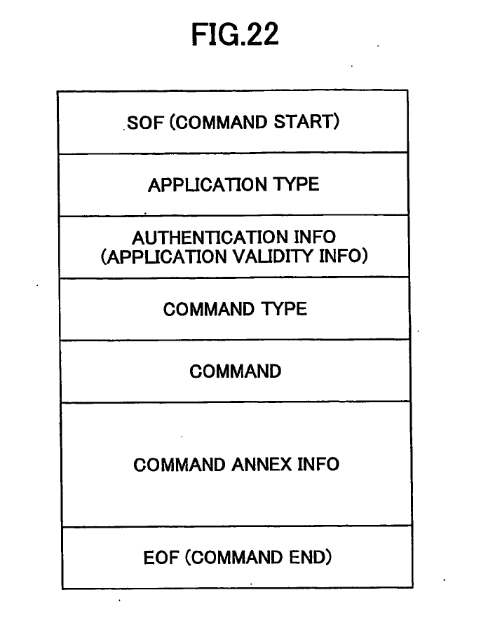

First, a description will be given of a first example (case where the authentication is successful) of the communication sequence between the external application 231 (or 232) and each of the image processing apparatuses, including the MFP 10, when the operation execution request command is issued from the external application 231 (or 232) by referring to FIGS. 21 and 22.

FIG. 21 is a diagram showing the first example of the communication sequence between the external application 231 (or 232) and the MFP 10 shown in FIG. 20 when the operation execution request command is issued from the external application 231 (or 232).

When one of the image processing apparatuses (MFP 10 in this particular case) that are connected to the network 1 is selected (specified) as the image processing apparatus to be used, and the function to be used is selected (of course, the function may be selected so that the image processing apparatus capable of executing the selected function is automatically selected), by the operation of the operation part 207, for example, the external application 231 (or 232) issues an operation execution request command which requests the selected function to be realized. The external application 231 (or 232) adds authentication information (application validity information) to this operation execution request command, and sends the operation execution request command to the MFP 10 which is the selected image processing apparatus (step S201). Actually, the application controlling part 242 sends the operation execution request command and other commands to the MFP 10 by the application communication processing part 241, similarly to the first embodiment described above. The authentication information is added to the operation execution request command every time the operation execution request command is sent to the MFP 10.

A description will be given of the structure of the commands exchanged between the MFP 10 and the external applications 231 and 232 shown in FIG. 20, by referring to FIG. 22.

FIG. 22 is a diagram showing the structure of commands exchanged between the MFP 10 and the external applications 231 and 232 shown in FIG. 20.

The command shown in FIG. 22 includes application type information, authentication information, the command type, the command (main body of command), the command annex information, and the tags (SOF, EOF) indicating the start and end of the command.

The application type information is related to the application, and indicates the type of the application, such as the copy application and the facsimile application.

The authentication information is the application validity information that is used when carrying out the authentication process in order to confirm the validity of the operation execution request command. The authentication information is formed by a sufficient number of bits so that the authentication information will not be easily copied, and is used as a password unique to the application.

The other information shown in FIG. 22, such as the command type, is the same as the corresponding information shown in FIG. 7, and a description thereof will be omitted.

Returning now to the description of FIG. 21, when the operation execution request command is sent from the external application 231, the communication processing part 121 of the MFP 10 receives (acquires) this operation execution request command and sends this operation execution request command to the application selecting part 122 (step S202).

The application selecting part 122 receives the operation execution request command from the communication processing part 121, and sends this operation execution request command to the controlling part 124 (step S203).

When the operation execution request command is received from the application selecting part 122, the controlling part 124 extracts only the authentication information from the operation execution request command, and sends an authentication request command to the authenticating part 125 by adding the authentication information to the authentication request command (step S204).

When the authentication request command is received from the controlling part 124, the authenticating part 125 sends an application information acquisition request command to the controlling part 124 (step S205).

When the application information acquisition request command is received from the authenticating part 125, the controlling part 124 sends to the application information storing part 123 the application information acquisition request command by adding thereto the IP address (application implemented location information) of the external application 231, for example, so as to acquire from the application information storing part 123 the information related to the external application 231 which is the source which issued the operation execution request command that has been acquired (step S206).

When the application information acquisition request command is received from the controlling part 124, the application information storing part 123 reads the information (application information) related to the external application 231 from the application management table which will be described later, based on the IP address that is added to this application information acquisition request command, and issues (generates) and sends to the controlling part 124 an application information notification command which includes the information (application information) related to the external application 231 (step S207).

When the application information notification command is received (acquired) from the application information storing part 123, the controlling part 124 sends this application information notification command to the authenticating part 125 (step S208).

When the application information notification command is received from the controlling part 124, the authenticating part 125 carries out the authentication process to confirm the validity of the operation execution request command that has been received by the controlling part 124. In other words, the authenticating part 125 collates the authentication information added to the operation execution request command that has been received and the application information that is added to the application information notification command to determine whether or not the two match (step S209). If the two collated information match, the authenticating part 125 judges that the authentication is successful (confirms the validity of the operation execution request command), and permits the execution of (access to) the application operation (command process) requested by the operation execution request command that has been acquired by the controlling part 124, and issues and sends to the controlling part 124 an access permission notification command which includes information indicating that the authentication was successful (validity of the operation execution request command has been confirmed) and the execution of (access to) the application operation (command process) requested by the operation execution request command that was acquired by the controlling part 124 has been permitted (step S210).

When the access permission notification command is received from the authenticating part 125, the controlling part 124 executes the application operation (command process) requested by the operation execution request command that has been acquired (step S211). In addition, the controlling part 124 issues and sends to the application selecting part 122 a process result notification command including information indicating the result of executing the application operation (step S212).

When the process result notification command is received from the controlling part 124, the application selecting part 122 sends this process result notification command to the communication processing part 121 (step S213).

When the process result notification command is received from the application selecting part 122, the communication processing part 121 sends this process result notification command to the external application 231 (step S214).

When the operation execution request command is issued from the external application 231, the image processing apparatuses other than the MFP 10 may carry out the process shown in FIG. 21 similarly to the MFP 10 described above.

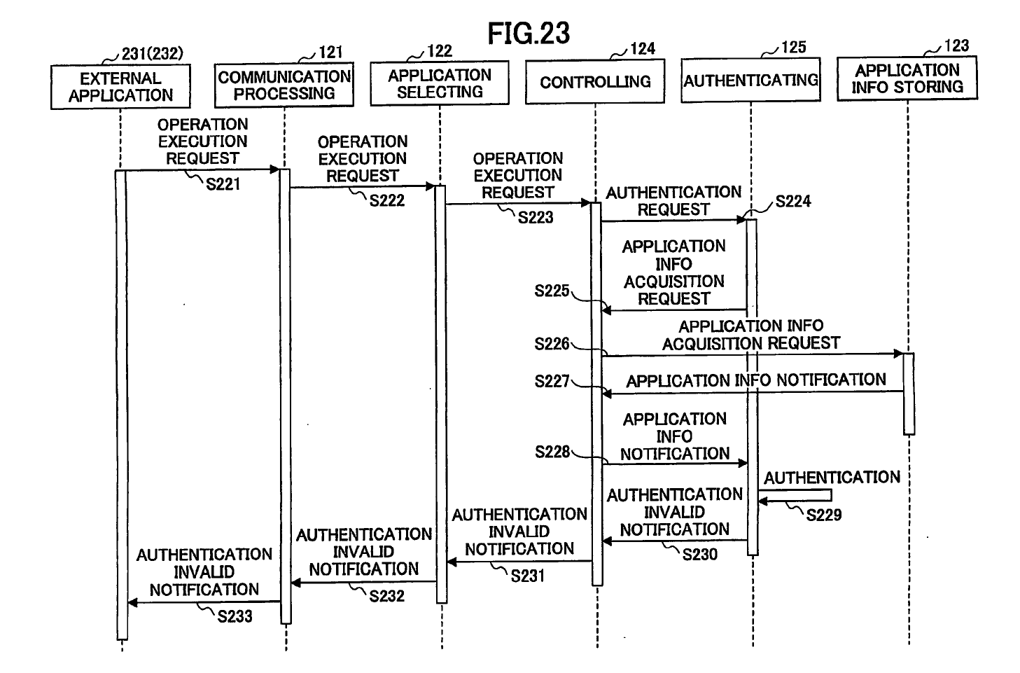

Next, a description will be given of a second example (case where the authentication is unsuccessful) of the communication sequence between the external application 231 (or 232) and each of the image processing apparatuses, including the MFP 10, when the operation execution request command is issued from the external application 231 (or 232) by referring to FIG. 23.

FIG. 23 is a diagram showing the second example of the communication sequence between the external application 231 (or 232) and the MFP 10 shown in FIG. 20 when the operation execution request command is issued from the external application 231 (or 232).

In FIG. 23, steps S221 through S228 are the same as those corresponding steps S201 through S208 shown in FIG. 21 described above, and a description thereof will be omitted. A description will thus be given of the process from a step S229.

When the application information notification command is received from the controlling part 124, the authenticating part 125 of the MFP 10 carries out the authentication process to confirm the validity of the operation execution request command that has been received by the controlling part 124. In other words, the authenticating part 125 collates the authentication information added to the operation execution request command that has been received and the application information that is added to the application information notification command to determine whether or not the two match (step S229). If the two collated information do not match, the authenticating part 125 judges that the authentication was unsuccessful (confirms the invalidity of the operation execution request command), and rejects the execution of (access to) the application operation (command process) requested by the operation execution request command, and issues and sends to the controlling part 124 an authentication invalid notification command (result notification command) including information indicating that the authentication was unsuccessful (invalidity of the operation execution request command has been confirmed) and the execution of (access to) the application operation (command process) requested by the operation execution request command that was acquired by the controlling part 124 has been rejected (step S230). Although the illustration thereof is omitted in FIG. 23, information indicating that an invalid access was made (invalid operation execution request command was received) is displayed on the operation part 107 of the MFP 10.

When the authentication invalid notification command is received from the authenticating part 125, the controlling part 124 sends the authentication invalid notification command with respect to the external application 231. In other words, the controlling part 124 sends the authentication invalid notification command to the external application 231 via the application selecting part 122 and the communication processing part 121 (steps S231 through S233).

When the authentication invalid notification command is received from the MFP 10, the external application 231 displays information indicating that an invalid access was made (invalid operation execution request command was issued) with respect to the MFP 10 is displayed on the operation part 207 shown in FIG. 4.

When the operation execution request command is issued from the external application 231, the image processing apparatuses other than the MFP 10 may carry out the process shown in FIG. 23 similarly to the MFP 10 described above.

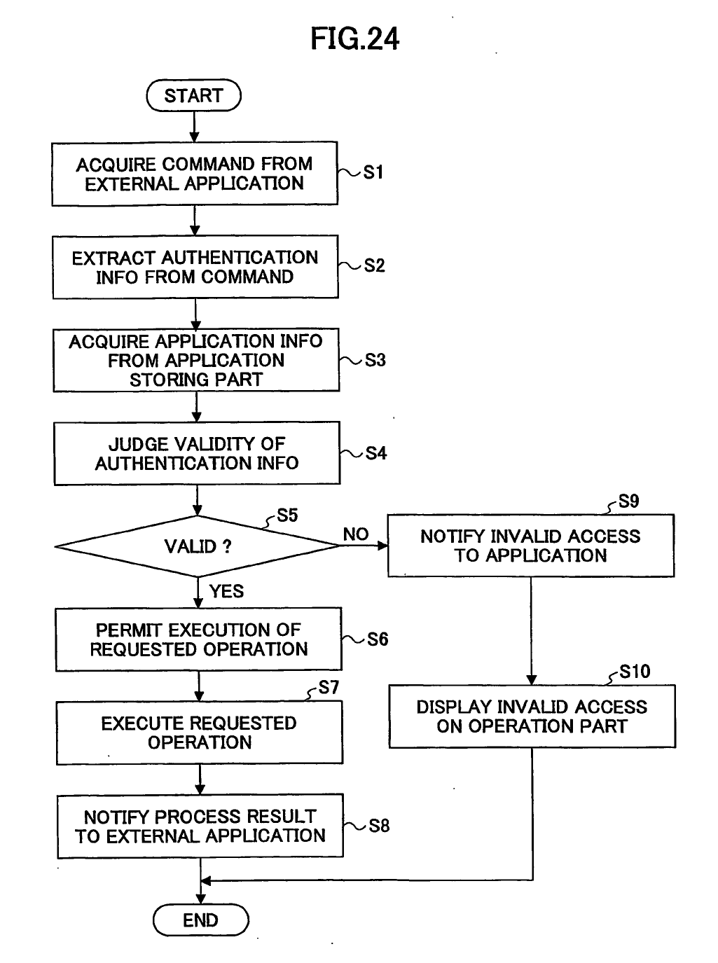

Next, a more detailed description will be given of the authentication process when the CPU 101 within the controller 11 of the MFP 10 receives the operation execution request command from the external application 231 (or 232), by-referring to FIG. 24. The image processing apparatuses, other than the MFP 10, may carry out the process similarly to the MFP 10, and thus, a description and illustration thereof will be omitted.

FIG. 24 is a flow chart for explaining a process of the CPU 101 within the controller 11 of the MFP 10 when the operation execution request command is received from the external application 231 (or 232).

When the operation execution request command from the external application 231 (or 232) is received via the MAC I/F 111, the USB I/F 109 or the IEEE1394 I/F 110, the CPU 101 of the MFP 10 starts the processing routine shown in FIG. 24. First, a step S1 acquires the operation execution request command, and a step S2 extracts the authentication information (application validity information) that is added (annexed) to the acquired operation execution request command. A step S3 acquires the corresponding application information (that i s registered in advance) from the application information storing part 123, and a step S4 carries out the authentication process to confirm the validity of the operation execution request command. In other words, the previously extracted authentication information and the application information are collated to determine whether or not the two information match.

A description will now be given of the authentication information and the application information.

As described above, the authentication information is the application validity information that is used when carrying out the authentication process to confirm the validity of the operation execution request command. Hence, the authentication information is desirably identification information (application identification number) unique to the application of the source which issues the operation execution request command. It is also possible to use as the authentication information the type information (application type information) which indicates the type of the application. In this case, the authentication information may be deleted from the command having the structure shown in FIG. 22.

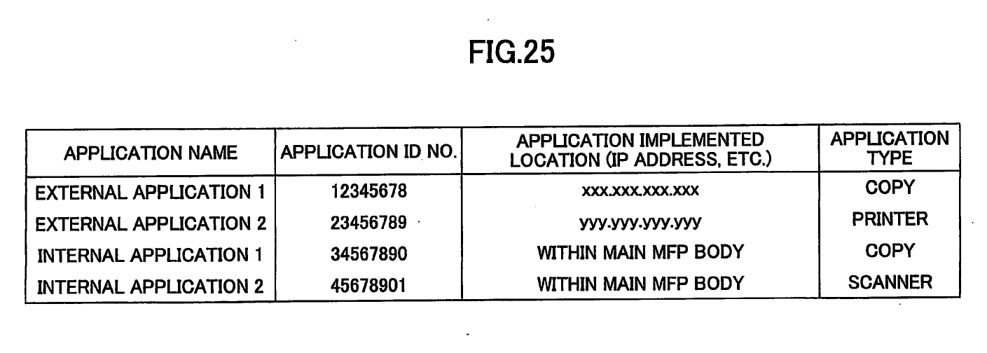

For example, the application management table shown in FIG. 25 is stored in the application information storing part 123. FIG. 25 is a diagram showing the application management table stored in the application information storing part 123 shown in FIG. 20.

As shown the FIG. 25, the application management table includes information (application information) indicating an application name, application identification number (application ID number), application implemented location information (IP address, etc.), and application type, for each of the applications (internal applications 131 and 132, external applications 231 and 232) for realizing the operation (function) executable in the MFP 10.

Accordingly, if the authentication information added to the operation execution request command is the application ID number, for example, the application information that is collated therewith must also be the application ID number. Alternatively, if the application type information added to the operation execution request command is used as the authentication information, for example, the application information that is collated therewith must also be the application type information. In this case, the authenticating part 125 must judge the application type information that is added to the operation execution request command, and the authenticating part 125 accordingly functions as an application type judging part.

Returning now to the description of FIG. 24, if the authentication information extracted from the operation execution request command and the application information acquired from the application information storing part 123 match, the CPU 101 of the MFP 10 judges in a step S5 (YES) that the authentication is successful (confirms validity of the operation execution request command). In a step S6, the CPU 101 of the MFP 10 permits execution of the application operation (command process) requested by the operation execution request command that has been acquired. In a step S7, the CPU 101 of the MFP 10 executes the application operation (command process) requested by the operation execution request command. Thereafter, in a step S8, the CPU 101 of the MFP 10 sends a result of executing the application operation (command process) to the external application 231, and the process ends.

If the authentication information extracted from the operation execution request command and the application information acquired from the application information storing part 123 do not match, the CPU 101 of the MFP 10 judges that the authentication was unsuccessful (authentication information is invalid) in the step S5 (NO). In a step S9, the CPU 101 of the MFP 10 rejects the execution (access by the external application) of the application operation (command process) requested by the operation execution request command that has been received, and issues and sends to the external application 231 an authentication invalid notification command including information indicating that the access by the external application is an invalid access. In addition, in a step S10, information indicating that the invalid access was made is displayed on the operation part 107, and the process ends.

If the application type information that is added to the received operation execution request command is used as the authentication information, this application type information is collated with the application type information (type information of the application for realizing the operation executable by the MFP 10) that is acquired from the application information storing part 123. For example, if the facsimile function (or facility) is not implemented in the MFP 10 and a facsimile operation execution request command is received from the external application 231, the application type information that is added (annexed) to the facsimile operation execution request command is collated with the application type information acquired from the application information storing part 123, but the two collated information will not match. In this case, it is judged that the authentication was unsuccessful (or failed), and that the facsimile operation cannot be executed.

In addition, if the CPU 101 of the MFP 10 judges that the authentication was unsuccessful, it is possible not to display on the operation part 107 the information indicating that the invalid access was made, but to add this information to invalid access log information (stored in the NVRAM 105 or HDD 106 shown in FIG. 2), so that the invalid access log information may later be displayed on the operation part 107 or printed on the recording medium such as paper by the plotter.

Furthermore, the image processing apparatuses other than the MFP 10 may carry out the process shown in FIG. 24 similarly to the MFP 10 described above.

According to the process described above in conjunction with FIGS. 21 through 25, the application information such as the application ID information and the application type information is acquired from the application information storing part 123. However, by initially storing the application information in the authenticating part 125, it is possible to judge the validity of the access without having to inquire the application information with respect to the application information storing part 123.

According to this first control example, each of the image processing apparatuses, including the MFP 10, executes the operation by using the external application, by communicating with the external application. Hence, since a common application can be used in common among the plurality of image processing apparatuses, each image processing apparatus can be produced at a low cost but can realize a plurality of functions. In addition, it is possible to reduce the operation of updating versions of the applications (functions). Furthermore, it is possible to improve the degree of freedom of designing the image processing apparatus, because it is possible to also use the internal applications as they are without having to make modifications. Moreover, because the authentication process to confirm the validity of the access is carried out with respect to each operation execution request command that is sent from the external application, it is possible to exclude the invalid access from the external application for each operation execution request command.

If the application ID information (identification information unique to the external application) is used as the authentication information that is added to the operation execution request command, it is possible to facilitate implementation of the applications to the image processing apparatus because the application ID information can be managed in the form of a management table and used when carrying out the authentication process.

If the application type information (type information of the application for realizing the operation executable in the image processing apparatus) is used as the authentication information that is added to the operation execution request command, it is possible to facilitate implementation of the applications to the image processing apparatus because the application type information can be managed in the form of a management table and used when carrying out the authentication process.

### SECOND CONTROL EXAMPLE

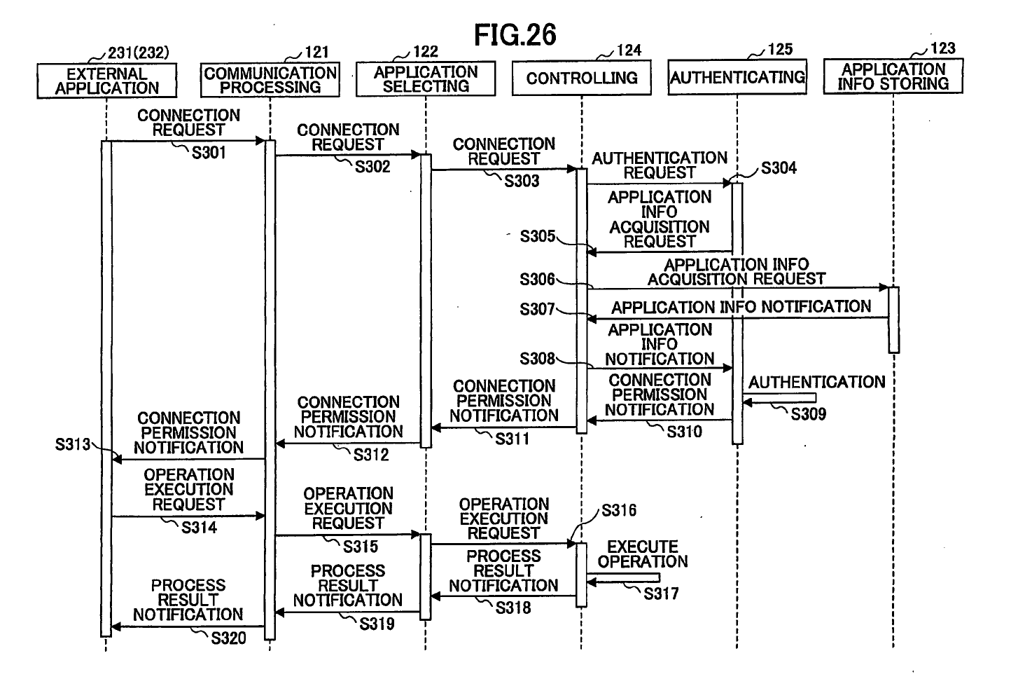

Next, a description will be given of a first example (case where the authentication is successful) of the communication sequence between the external application 231 (or 232) and each of the image processing apparatuses, including the MFP 10, when the application connection request command is issued from the external application 231 (or 232) by referring to FIG. 26.

FIG. 26 is a diagram showing the first example of the communication sequence between the external application 231 (or 232) and the MFP 10 shown in FIG. 20 when the application connection request command is issued from the external application 231 (or 232).

When one of the image processing apparatuses (MFP 10 in this particular case) that are connected to the network 1 is selected (specified) as the image processing apparatus to be used, and the function to be used is selected (of course, the function may be selected so that the image processing apparatus capable of executing the selected function is automatically selected), by the operation of the operation part 207, for example, the external application 231 (or 232) issues a connection request command (application connection request command). The external application 231 (or 232) adds authentication information (application validity information) to this application connection request command, and sends the application connection request command to the MFP 10 which is the selected image processing apparatus (step S301).

When the application connection request command is sent from the external application 231, the communication processing part 121 of the MFP 10 receives (acquires) this application connection request command and sends this application connection request command to the application selecting part 122 (step S302).

The application selecting part 122 receives the application connection request command from the communication processing part 121, and sends this application connection request command to the controlling part 124 (step S303).

When the application connection request command is received from the application selecting part 122, the controlling part 124 extracts only the authentication information from the application connection request command, and sends an authentication request command to the authenticating part 125 by adding the authentication information to the authentication request command (step S304).

When the authentication request command is received from the controlling part 124, the authenticating part 125 sends an application information acquisition request command to the controlling part 124 (step S305).

When the application information acquisition request command is received from the authenticating part 125, the controlling part 124 sends to the application information storing part 123 the application information acquisition request command by adding thereto the IP address (application implemented location information) of the external application 231, for example, so as to acquire from the application information storing part 123 the information related to the external application 231 which is the source which issued the application connection request command that has been acquired (step S306).

When the application information acquisition request command is received from the controlling part 124, the application information storing part 123 reads the information (application information) related to the external application 231 from the application management table shown in FIG. 25, based on the IP address that is added to this application information acquisition request command, and issues (generates) and sends to the controlling part 124 an application information notification command which includes the information (application information) related to the external application 231 (step S307).

When the application information notification command is received (acquired) from the application information storing part 123, the controlling part 124 sends this application information notification command to the authenticating part 125 (step S308).

When the application information notification command is received from the controlling part 124, the authenticating part 125 carries out the authentication process to confirm the validity of the application connection request command that has been received by the controlling part 124. In other words, the authenticating part 125 collates the authentication information added to the application connection request command that has been received and the application information that is added to the application information notification command to determine whether or not the two match (step S309). If the two collated information match, the authenticating part 125 judges that the authentication is successful (confirms the validity of the application connection request command), and permits the connection of MFP 10 and the external application 231 (use of the MFP 10) requested by the application connection request command that has been acquired by the controlling part 124, and issues and sends to the controlling part 124 a connection permission notification command (or device usability notification command) which includes information indicating that the authentication was successful (validity of the application connection request command has been confirmed) and the connection of the MFP 10 and the external application 231 requested by the application connection request command that was acquired by the controlling part 124 has been permitted (step S310).

When the connection permission notification command is received from the authenticating part 125, the controlling part 124 sends this connection permission notification command to the application selecting part 122 (step S311).

When the connection permission notification command is received from the controlling part 124, the application selecting part 122 sends this connection permission notification command to the communication processing part 121 (step S312).

When the connection permission notification command is received from the application selecting part 122, the communication processing part 121 sends this connection permission notification command to the external application 231 (step S313).

When the connection permission notification command is received from the MFP 10, the external application 231 recognizes that the external application 231 and the MFP 10 have been communicatably connected and the MFP 10 has become usable (accessible), and issues and sends to the MFP 10 an operation execution request command for realizing the function that has been selected (step S314).

When the operation execution request command is sent from the external application 231, the communication processing part 121 of the MFP 10 sends the received (acquired) operation execution request command to the application selecting part 122 (step S315).

When the operation execution request command is received from the communication processing part 121, the application selecting part 122 sends this operation execution request command to the controlling part 124 (step S316).

When the operation execution request command is received from the application selecting part 122, the controlling part 124 executes the application operation (command process) requested by this operation execution request command (step S317), and issues and sends to the application selecting part 122 a process result notification command including information indicating the result of executing the application operation (step S318).

When the process result notification command is received from the controlling part 124, the application selecting part 122 sends this process result notification command to the communication processing part 121 (step S319).

When the process result notification command is received from the application selecting part 122, the communication processing part 121 sends this process result notification command to the external application 231 (step S320).

When the application connection request command is issued from the external application 231, the image processing apparatuses other than the MFP 10 may carry out the process shown in FIG. 26 similarly to the MFP 10 described above.

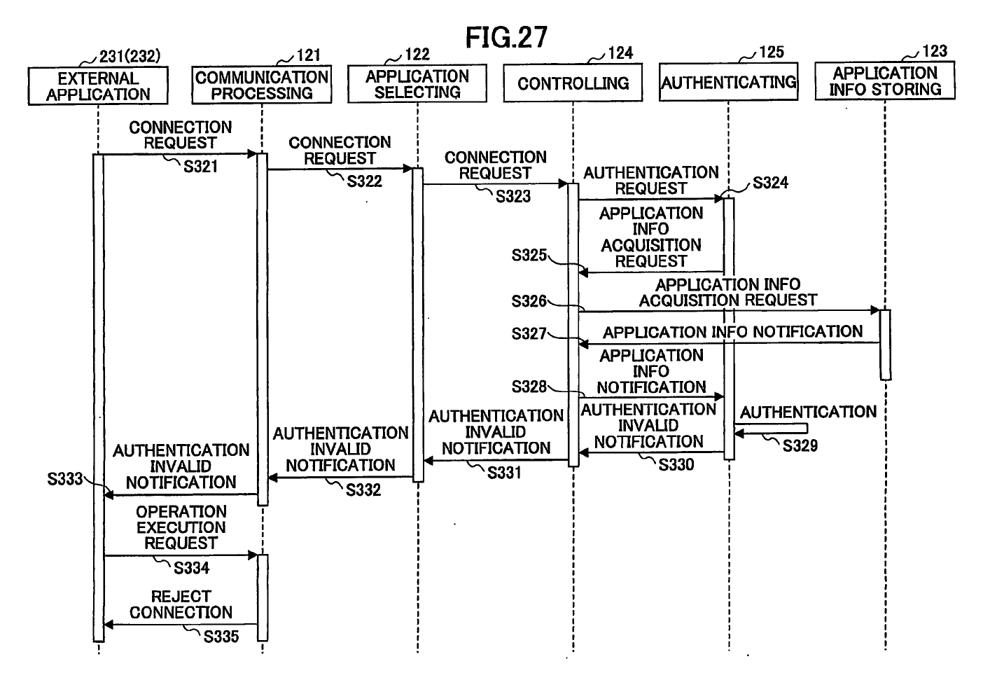

Next, a description will be given of a second example (case where the authentication is unsuccessful) of the communication sequence between the external application 231 (or 232) and each of the image processing apparatuses, including the MFP 10, when the application connection request command is issued from the external application 231 (or 232) by referring to FIG. 27.

FIG. 27 is a diagram showing the second example of the communication sequence between the external application 231 (or 232) and the MFP 10 shown in FIG. 20 when the application connection request command is issued from the external application 231 (or 232).

In FIG. 27, steps S321 through S328 are the same as those corresponding steps S301 through S308 shown in FIG. 26 described above, and a description thereof will be omitted. A description will thus be given of the process from a step S329.

When the application information notification command is received from the controlling part 124, the authenticating part 125 of the MFP 10 carries out the authentication process to confirm the validity of the application connection request command that has been received by the controlling part 124. In other words, the authenticating part 125 collates the authentication information added to the application connection request command that has been received and the application information that is added to the application information notification command to determine whether or not the two match (step S329). If the two collated information do not match, the authenticating part 125 judges that the authentication was unsuccessful (confirms the invalidity of the application connection request command), and issues and sends to the controlling part 124 an authentication invalid notification command (result notification command) including information indicating that the authentication was unsuccessful (invalidity of the application connection request command has been confirmed) (step S330).

When the authentication invalid notification command is received from the authenticating part 125, the controlling part 124 sends the authentication invalid notification command to the application selecting part 122 (step S331).

When the authentication invalid notification command is received from the controlling part 124, the application selecting part 122 sends this authentication invalid notification command to the communication processing part 121 (step S332).

When the authentication invalid notification command is received from the application selecting part 122, the communication processing part 121 sends this authentication invalid notification command to the external application 231 (step S333).

After the communication processing part 121 of the MFP 10 sends the authentication invalid notification command to the external application 231, if the communication processing part 121 receives an operation execution request command from the external application 231, the communication processing part 121 sends to the external application 231 a connection reject command rejecting the connection of the MFP 10 to the external application 231 (steps S334 and S335).

When the application connection request command is issued from the external application 231, the image processing apparatuses other than the MFP 10 may carry out the process shown in FIG. 27 similarly to the MFP 10 described above.

According to this second control example, each of the image processing apparatuses, including the MFP 10, executes the operation by using the external application, by communicating with the external application. Hence, since a common application can be used in common among the plurality of image processing apparatuses, each image processing apparatus can be produced at a low cost but can realize a plurality of functions. In addition, it is possible to reduce the operation of updating versions of the applications (functions). Furthermore, it is possible to improve the degree of freedom of designing the image processing apparatus, because it is possible to also use the internal applications as they are without having to make modifications. Moreover, because the authentication process is carried out to confirm the validity of the first application connection request command that is sent from the external application and the access (connection) is permitted with respect to the external application if the authentication is successful, and the operation (access) requested by the subsequent operation execution request command is carried out immediately without carrying out the authentication process with respect to the subsequent operation execution request command, it is possible to exclude the invalid access from the external application for each application connection request command.

In the authentication process described above, the validity of the operation execution request command or the application connection request command is confirmed. In other words, the validity of the external application which issued the operation execution request command or the application connection request command is confirmed. However, the authentication process may confirm the validity of the external server including the external application.

### THIRD CONTROL EXAMPLE

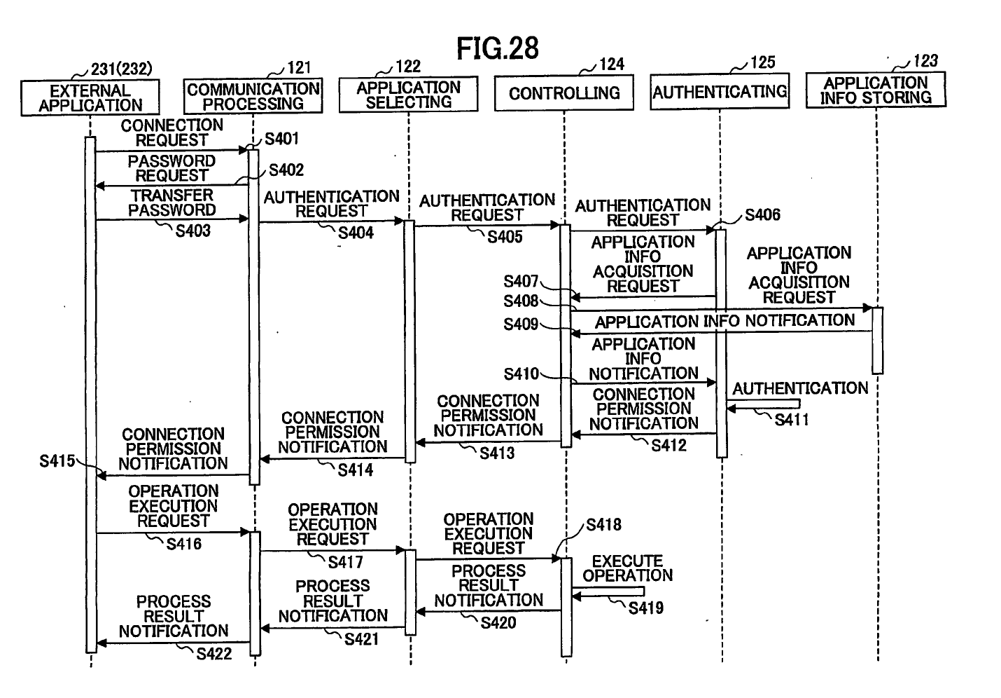

Next, a description will be given of a third example (case where the authentication is successful) of the communication sequence between the external application 231 (or 232) and each of the image processing apparatuses, including the MFP 10, when the application connection request command is issued from the external application 231 (or 232) by referring to FIG. 28.

FIG. 28 is a diagram showing the third example of the communication sequence between the external application 231 (or 232) and the MFP 10 shown in FIG. 20 when the application connection request command is issued from the external application 231 (or 232).

When one of the image processing apparatuses (MFP 10 in this particular case) that are connected to the network 1 is selected (specified) as the image processing apparatus to be used, and the function to be used is selected (of course, the function may be selected so that the image processing apparatus capable of executing the selected function is automatically selected), by the operation of the operation part 207, for example, the external application 231 (or 232) issues a connection request command (application connection request command) and sends the application connection request command to the MFP 10 which is the selected image processing apparatus (step S401).

When the application connection request command is sent from the external application 231, the communication processing part 121 of the MFP 10 sends a password request command which requests a password to the external application 231 which is the source that issued the application connection request command (step S402).

When the password request command is received (acquired) from the MFP 10, the external application 231 sends a password transfer command, including a password that is registered in advance (stored in the NVRAM 205 or HDD 206 shown in FIG. 4), to the MFP 10 which is the source that issued the password request command (step S403).

The communication sequence from the step S401 to the step S403 forms a predetermined communication sequence.

When the password transfer command is received from the external application 231, the communication processing part 121 of the MFP 10 extracts only the password from the password transfer command and sends an authentication request command to the application selecting part 122 by adding the password to this authentication request command (step S404).

When the authentication request command is received from the communication processing part 121, the application selecting part 122 sends this authentication request command to the controlling part 124 (step S405).

When the authentication request command is received from the application selecting part 122, the controlling part 124 sends this authentication request command to the authenticating part 125 (step S406).

When the authentication request command is received from the controlling part 124, the authenticating part 125 extracts the password (authentication information) from the authentication request command, and sends an application information acquisition request command to the controlling part 124 (step S407).

When the application information acquisition request command is received from the authenticating part 125, the controlling part 124 sends this application information acquisition request command to the application information storing part 123 by adding the UP address of the external application 231 to this application information acquisition request, for example, in order to acquire the password corresponding to the external application 231 from the application information storing part 123 (step S408).

When the application information acquisition request command is received from the controlling part 124, the application information storing part 123 reads from the application management table the password corresponding to the external application 231 from the IP address that is added to the application information acquisition request command, and issues and sends to the controlling part 124 an application information notification command including the password (step S409).

When the application information notification command is received from the application information storing part 123, the controlling part 124 sends this application information notification command to the authenticating part 125 (step S410).

When the application information notification command is received from the controlling part 124, the authenticating part 125 carries out an authentication process to confirm the validity of the application connection request command that has been received by the controlling part 124. In other words, the authenticating part 125 collates the password added to the authentication request command that has been received and the password added to the application information notification command (step S411). If the two collated passwords match, the authenticating part 125 judges that the authentication is successful (confirms validity of the application connection request command) and permits the connection between the MFP 10 and the external application 231 (permits use of the MFP 10), and issues and sends to the controlling part 124 a connection permission notification command (or device usability notification command) including information indicating that the authentication was successful (step S412).

The communication sequence of subsequent steps S413 through S422 is the same as the communication sequence of the steps S311 through S320 shown in FIG. 26, and a description thereof will be omitted.

It is possible to carry out the following process in place of the process of the steps S402 through S411 shown in FIG. 28.

That is, when the communication processing part 121 of the MFP 10 receives the application connection request command from the external application 231, the communication processing part 121 sends to the external application 231 a password request command including a random number generated by the authenticating part 125. In this case, the communication processing part 121 actually issues a random number request command which requests the random number, and sends this random number request command to the authenticating part 125 via the application selecting part 122 and the controlling part 124. As a result, the authenticating part 125 generates the random number in response to the random number request command, and sends the random number to the communication processing part 121 via the controlling part 124 and the application selecting part 122.

When the password request command is received from the MFP 10, the external application 231 analyzes (or interprets) the random number added to this password request command according to a predetermined (or determined) method to generate the password, and sends to the MFP 10 a password transfer command including the generated password.

When the password transfer command is received from the external application 231, the communication processing part 121 of the MFP 10 extracts only the password from the password transfer command, and sends an authentication request command to the application selecting part 122 by adding the password to the authentication request command.

When the authentication request command is received from the communication processing part 121, the application selecting part 122 sends this authentication request command to the controlling part 124.

When the authentication request command is received from the application selecting part 122, the controlling part 124 sends this authentication request command to the authenticating part 125.

When the authentication request command is received from the controlling part 124, the authenticating part 125 extracts the password from this authentication request command, and carries out an authentication process for confirming the validity of the application connection request command by collating the password with the random number that has been generated.

Alternatively, it is possible to carry out the following process in place of the process of the steps S402 through S415 shown in FIG. 28.

That is, when the application connection request command is received from the external application 231, the communication processing part 121 of the MFP 10 sends to the external application 231 a first personal identification information request command which requests first personal identification information (personal identification number, etc.

When the first personal identification information request command is received from the MFP 10, the external application 231 sends to the MFP 10 a first personal identification information transfer command including the first personal identification information which is predetermined.

When the first personal identification information transfer command is received from the external application 231, the communication processing part 121 of the MFP 10 sends to the external application 231 a second personal identification information request command which requests two second personal identification information.

When the second personal identification information request command is received from the MFP 10, the external application 231 sends to the MFP 10, two times, by repeating, a second personal identification information transfer command including the second personal identification information which is predetermined.

When the second personal identification information transfer command is received two times from the external application 231, the communication processing part 121 of the MFP 10 sends to the external application 231 a third personal identification information request command which requests three third personal identification information.

When the third personal identification information request command is received from the MFP 10, the external application sends to the MFP 10, three times, by repeating, a third personal identification information transfer command including third personal identification information which is predetermined.

When the third personal identification information transfer command is received three times from the external application 231, the communication processing part 121 of the MFP 10 judges that the communication sequence is in accordance with a predetermined protocol and that the authentication is successful. Hence, the communication processing part 121 permits the connection of the MFP 10 and the external application 231, and sends to the external application 231 a connection permission notification command including information indicating that the authentication was successful.

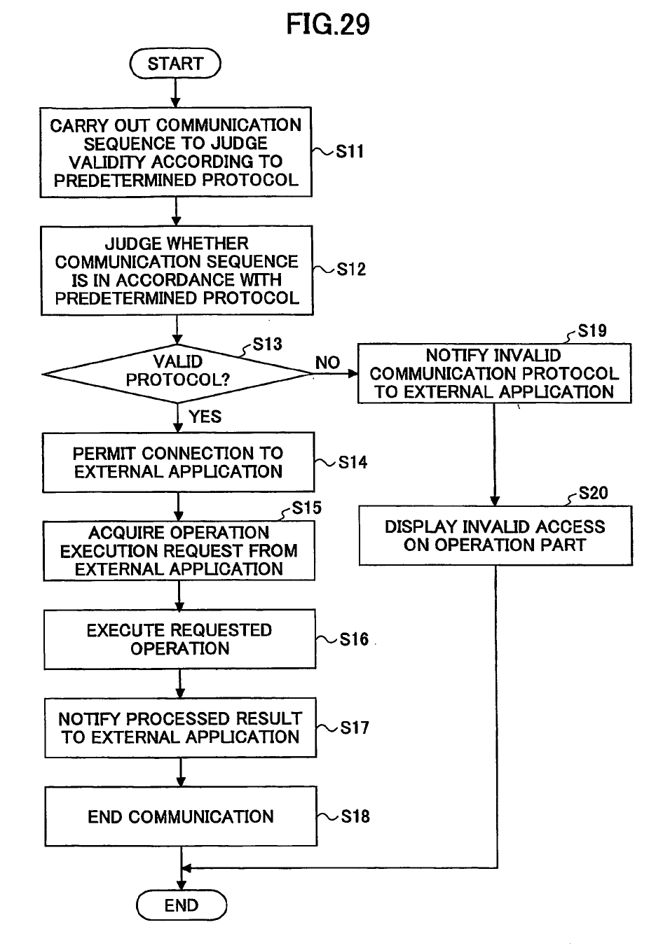

Next, a more detailed description will be given of the process of the CPU 101 within the controller 11 of the MFP 10 when acquiring the application connection request command from the external application 231 (or 232), by referring to FIG. 29. Since the image processing apparatuses other than the MFP 10 carry out processes similar to that of the MFP 10, a description and illustration thereof will be omitted.

FIG. 29 is a flow chart for explaining the process of the CPU 101 within the controller 11 of the MFP 10 shown in FIG. 20 when the application connection request command is acquired from the external application.

When the application connection request command from the external application 231 (or 232) is received via the MAC I/F 111, the USB I/F 109 or the IEEE1394 I/F 110, the CPU 101 of the MFP 10 starts the processing routine shown in FIG. 29. First, a step S11 acquires the application connection request command, and carries out a communication sequence for confirming the validity of this application connection request command according to a protocol that is predetermined between the MFP 10 and the external application 231.

Then, a step S12 carries out an authentication process to confirm the validity of the application connection request command by this communication sequence. In other words, a judgement is made to determine whether or not the communication sequence is in accordance with the protocol described above (for example, whether or not the password added to the password transfer command acquired from the external application 231 matches the password added to the application information acquired from the application information storing part 123). If the communication sequence is in accordance with the protocol described above (for example, if the two passwords match), a step S13 judges (YES) that the authentication is successful (the protocol is valid, and confirms validity of the application connection request command), and a step S14 permits the connection (communication) between the MFP 10 and the external application 231 and sends to the external application 231 a connection permission notification command including information indicating that the connection (communication) is permitted.

Accordingly, a step S15 acquires the operation execution request command from the external application 231, and a step S16 executes the application operation (command process) requested by this operation execution request command. A step S17 sends a result of executing the application operation to the external application 231. A step S18 ends the communication of the MFP 10 with the external application 231, and the process ends.

If the communication sequence is not in accordance with the protocol described above, the step S13 judges (NO) that the authentication is unsuccessful (the protocol is invalid), and a step S19 rejects the execution (access by the external application 231) of the application operation (command process) requested by the operation execution request command. In addition, the step S19 issues and sends to the external application 231 an authentication invalid notification command including information that indicates that the communication protocol is an invalid protocol. Further, a step S20 displays on the operation part 107 information indicating that an invalid access was made, and the process ends.

If the CPU 101 of the MFP 10 judges that the authentication was unsuccessful, it is possible not to display on the operation part 107 the information indicating that the invalid access was made, but to add this information to invalid access log information (stored in the NVRAM 105 or HDD 106 shown in FIG. 2), so that the invalid access log information may later be displayed on the operation part 107 or printed on the recording medium such as paper by the plotter.

When the operation execution request command is issued from the external application 231, the image processing apparatuses other than the MFP 10 may carry out the process shown in FIG. 29 similarly to the MFP 10 described above.

According to this third control example, it is possible to obtain effects similar to those obtainable in the second control example. In addition, when the application connection request command is received from the external application, each of the image processing apparatuses, including the MFP 10, may carry out the communication sequence for confirming the validity of the application connection request command according to the protocol which is predetermined between each of the image processing apparatuses and the external application, so as to carry out an authentication process for confirming the validity of the application connection request command from the communication sequence. Hence, it is possible to realize a more strict application access management compared to the case where the authentication process is carried out using only the authentication information that is added to the application connection request command. However, when the authentication process is carried out using also the authentication information that is added to the application connection request command, it is possible to realize a more strict application access management.

### FOURTH CONTROL EXAMPLE

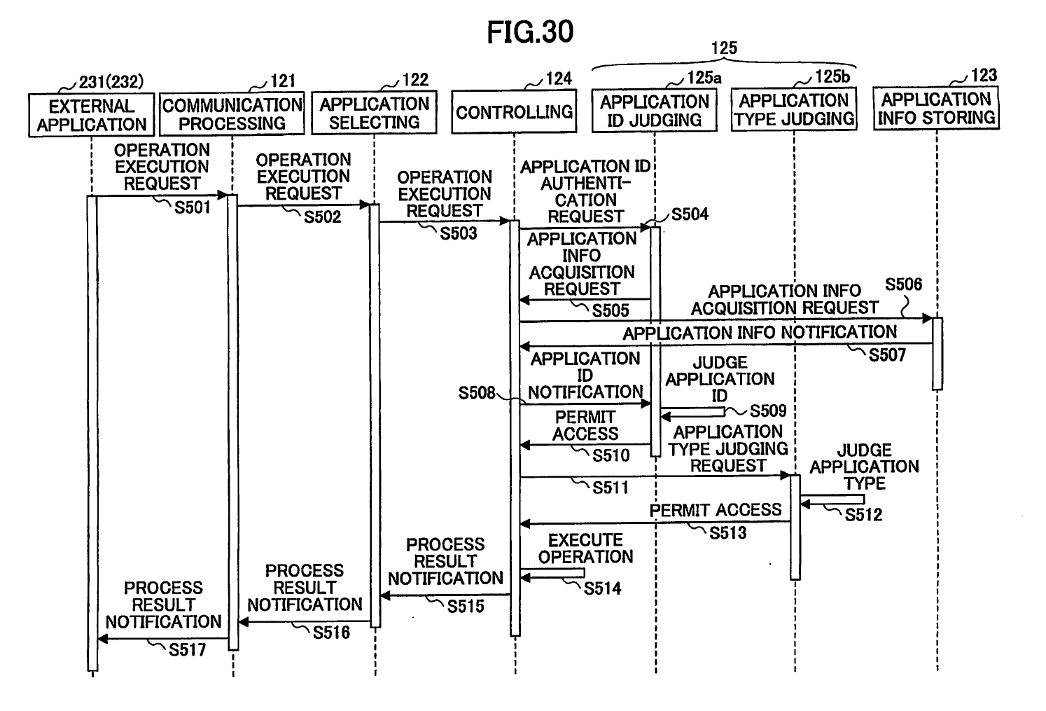

Next, a description will be given of a fourth example (case where the authentication is successful) of the communication sequence between the external application 231 (or 232) and each of the image processing apparatuses, including the MFP 10, when the operation execution request command is issued from the external application 231 (or 232) by referring to FIG. 30.

FIG. 30 is a diagram showing the fourth example of the communication sequence between the external application 231 (or 232) and the MFP 10 shown in FIG. 20 when the operation execution request command is issued from the external application 231 (or 232). For the sake of convenience, it is assumed that the authenticating part 125 includes functions of an ID judging part 125a and an application type judging part 125b.

When one of the image processing apparatuses (MFP 10 in this particular case) that are connected to the network 1 is selected (specified) as the image processing apparatus to be used, and the function to be used is selected (of course, the function may be selected so that the image processing apparatus capable of executing the selected function is automatically selected), by the operation of the operation part 207, for example, the external application 231 (or 232) issues an operation execution request command which requests execution of the selected function and sends the operation execution request command to the MFP 10 which is the selected image processing apparatus (step S501). Actually, the application controlling part 242 sends the operation execution request command and other commands to the MFP 10 by the application communication processing part 241, similarly to the first embodiment described above.

When the operation execution request command is sent from the external application 231, the communication processing part 121 of the MFP 10 receives (acquires) this operation execution request command and sends this operation execution request command to the application selecting part 122 (step S502).

When the operation execution request command is received from the communication processing part 121, the application selecting part 122 sends this operation execution request command to the controlling part 124 (step S503).

When the operation execution request command is received from the application selecting part 122, the controlling part 124 extracts only the application ID information from the operation execution request command, and sends an application ID authentication request command to the application ID judging part 125a by adding the extracted application ID information to this application ID authentication request command (step S504).

When the application ID authentication request command is received from the controlling part 124, the application ID judging part 125a sends an application information acquisition request command to the controlling part 124 (step S505).

When the application information acquisition request command is received from the authenticating part 125, the controlling part 124 sends the application information acquisition request command to the application information storing part 123 by adding the IP address (application implemented location information) of the external application 231, for example, so as to acquire from the application information storing part 123 the information related to the external application 231 which is the source that issued the operation execution request command that has been received (step S506).

When the application information acquisition request command is received from the controlling part 124, the application information storing part 123 reads the information (application information) related to the external application 231 from the application management table based on the IP address that is added to the application information acquisition request command, and issues and sends to the controlling part 124 an application information notification command that includes the application information (step S507).

When the application information notification command is received from the application information storing part 123, the controlling part 124 sends this application information notification command to the application ID judging part 125a (step S508).

When the application information notification command is received from the controlling part 124, the application ID judging part 125a carries out a first authentication process to confirm the validity of the operation execution request command received by the controlling part 124. In other words, the application ID judging part 125a collates the application ID information added to the application ID authentication request command that has been received and the application ID information within the application information added to the application information notification command (step S509). If the two collated application ID information match, the application ID judging part 125a judges that the application ID authentication is successful and permits the execution (access) of the application operation (command process) requested by the operation execution request command that has been acquired by the controlling part 124, and issues and sends to the controlling part 124 an access permission notification command including information indicating that the application ID authentication was successful (step S510).

When the access permission notification command is received from the application ID judging part 125a, the controlling part 124 extracts only the application type information from the operation execution request command that has been received from the application selecting part, and extracts the application type information from the application information notification command that has been received from the application information storing part 123, to send to the application type judging part 125b an application type judging request command including the two extracted application type information (step S511).

When the application type judging request command is received from the controlling part 124, the application type judging part 125b carries out a second authentication process to confirm the validity of the operation execution request command that has been received by the controlling part 124. In other words, the application type judging part 125b collates the two application type information added to the application type judging request command (step S512). If the two collated application type information match, the application type judging part 125b judges that the application type authentication is successful (confirms validity of the operation execution request command) and permits execution of the application operation (command process) requested by the operation execution request command that has been acquired by the controlling part 124, and issues and sends to the controlling part. 124 an access permission notification command including information indicating that the application type authentication was successful (step S513).

When the access permission notification command is also received from the application type judging part 125b, the controlling part 124 executes the application operation (command process) requested by the operation execution request command that has been received (step S514). In addition, the controlling part 124 issues and sends to the application selecting part 122 a process result notification command including information indicating the result of executing the application operation (step S515).

The application selecting part 122 receives the process result notification command from the controlling part 124, and sends this process result notification command to the communication processing part 121 (step S516).

When the process result notification command is received from the application selecting part 122, the communication processing part 121 sends this process result notification command to the external application 231 (step S517).

If the two collated application ID information do not match, the application ID judging part 125a judges that the application ID authentication is unsuccessful and rejects the execution of the application operation requested by the operation execution request command, and issues and sends to the controlling part 124 an authentication invalid notification command (result notification command) including information indicating that the application ID authentication was unsuccessful. In addition, information indicating that an invalid access was made is displayed on the operation part 107. If the two collated application type information do not match, the application type judging part 125b judges that the application type authentication is unsuccessful and rejects the execution of the application operation requested by the operation execution request command, and issues and sends to the controlling part 124 an authentication invalid notification command including information indicating that the application type authentication was unsuccessful. In addition, information indicating that an invalid access was made is displayed on the operation part 107.

When the authentication invalid notification command is received from the application ID judging part 125a or the application type judging part 125b, the controlling part 124 issues this authentication invalid notification command with respect to the external application 231. In other words, the controlling part 124 sends the authentication invalid notification command to the external application 231 via the application selecting part 122 and the communication processing part 121.

When the authentication invalid notification command is received from the MFP 10, the external application 231 displays on the operation part 207 shown in FIG. 4 information indicating that the access to the MFP 10 was an invalid access.

When the operation execution request command is issued from the external application 231, the image processing apparatuses other than the MFP 10 may carry out the process shown in FIG. 30 similarly to the MFP 10 described above.

According to this fourth control example, it is possible to obtain effects similar to those obtainable in the first control example described above. However, when each of the image processing apparatuses, including the MFP 10, carries out the authentication process to confirm the validity of each operation execution request command sent from the external application, the invalid access from the external application can be more positively excluded compared to the first control example described above, because the two authentication information (application ID information, application type information) added to the operation execution request command is used for the authentication process. In other words, it is possible to realize a more strict application access management.

### FIFTH CONTROL EXAMPLE

In a case where the MFP 10 (or other image processing apparatus) does not have the authenticating part 125 (application ID judging part 125a or application type judging part 125b), it is possible to set and register in advance by a key operation from the operation part 107 (writing in the application management table in the application information storing part 123) the application ID information or the application type information that is the identification information (information related to the application) unique to the application with respect to which the access is to be permitted (or rejected), so as to carry-out the authentication process (application ID authentication or application type authentication) described above according to the registered information.

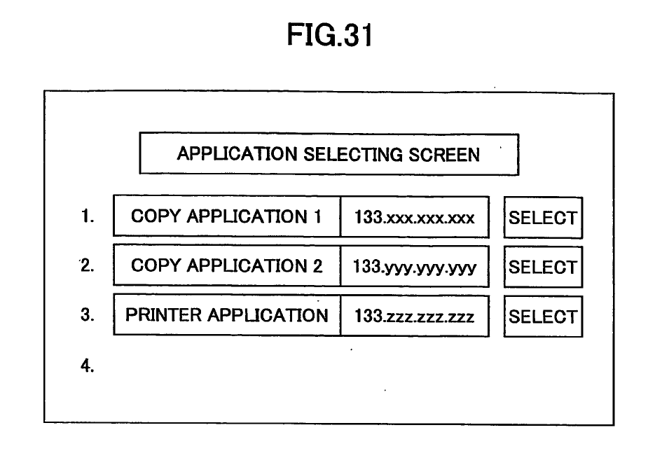

Alternatively, in a case where the MFP 10 (or other image processing apparatus) has a function of automatically searching the applications (external applications 231 and 232) of the external servers 20 and registering the application which responds as a usable application (writing information related to the application in the application management table of the application information storing part 123), identification information unique to the application with respect to which the access is to be permitted (or rejected) may be registered in advance, and the applications accessible to the MFP 10 may be restricted by a key operation from the operation part 107 (key operation made by a manager or user of the MFP 10). In this case, an application selecting screen shown in FIG. 31, for example, is displayed on the operation part 107. FIG. 31 is a diagram showing an example of the application selecting screen displayed on the operation part 107 shown in FIG. 20. The information related to the applications, such as the IP address or the application name and the application type, is displayed in the application selecting screen shown in FIG. 31 for each application. Hence, by selecting (specifying) the application with respect to which the access is to be permitted (or rejected) by making a key operation from the operation part 107 (touching corresponding keys if the touch panel is provided on the display screen), it is possible to permit (or reject) access from only the selected application.

According to this fifth control example, it is possible to obtain effects similar to those obtainable in the first control example described above. However, when each of the image processing apparatuses, including the MFP 10, sets (registers) in advance the information unique to the application with respect to which the access to this image processing apparatus is to be permitted or rejected, and carries out the authentication process to confirm the validity of each operation execution request command sent from the external application, by collating the identification information (authentication information) added to the operation execution request command and the registered identification information peculiar to the application, it is possible to use the image processing apparatus with an improved security because the application operation is permitted or rejected depending on whether or not the two collated identification information match.

### SIXTH CONTROL EXAMPLE

Next, a description will be given of a fifth example of the communication sequence between the external application 231 (or 232) and each of the image processing apparatuses, including the MFP 10, when the operation execution request command is issued from the external application 231 (or 232), by referring to FIG. 31.

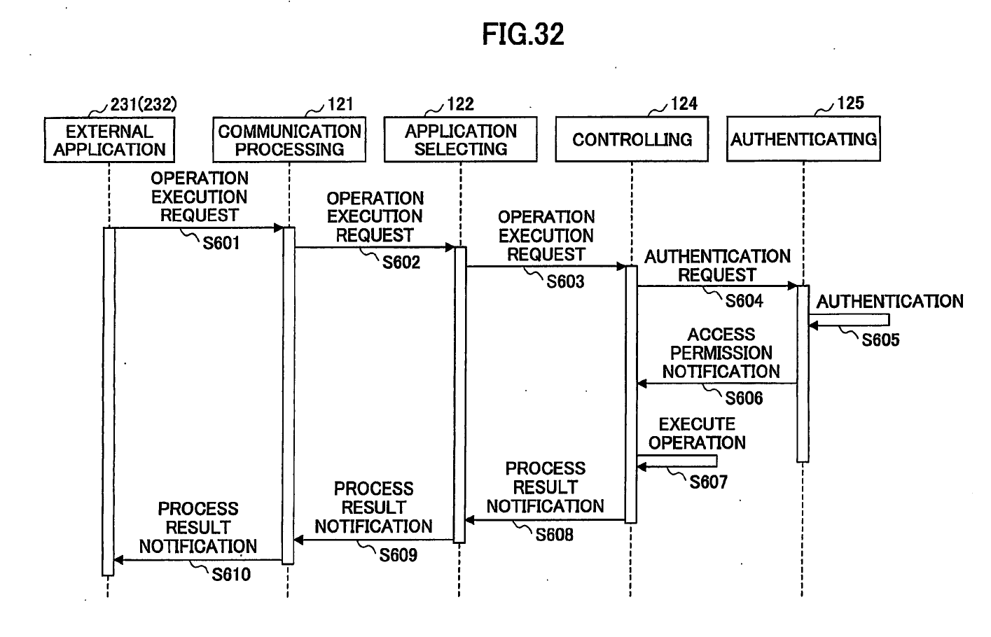

FIG. 32 is a diagram showing the fifth example of the communication sequence between the external application 231 (or 232) and the MFP 10 shown in FIG. 20 when the operation execution request command is issued from the external application 231 (or 232).

The controlling part 124 registers (writes and stores in the NVRAM 105 or HDD 106 shown in FIG. 2) in advance line type information indicating the type of communication line to which the access is permitted (or rejected) or communication method type information indicating the type of communication method used for the communication between the MFP 10 and the external application 231 (or 232), by making a key operation from the operation part 107.

When one of the image processing apparatuses (MFP 10 in this particular case) that are connected to the network 1 is selected (specified) as the image processing apparatus to be used, and the function to be used is selected (of course, the function may be selected so that the image processing apparatus capable of executing the selected function is automatically selected), by the operation of the operation part 207, for example, the external application 231 (or 232) issues an operation execution request command which requests execution of the selected function and sends the operation execution request command to the MFP 10 which is the selected image processing apparatus (step S601).

When the operation execution request command is sent from the external application 231, the communication processing part 121 of the MFP 10 judges the type of communication line which transferred the operation execution request command or the type of communication method used for the transfer of the operation execution request command from the external application 231 to the MFP 10. In addition, the communication processing part 121 adds the line type information or the communication method type information, which indicates the judgement result, to the operation execution request command, before sending the operation execution request command to the application selecting part 122 (step S602).

When the operation execution request command is received from the communication processing part 121, the application selecting part 122 sends this operation execution request command to the controlling part 124 (step S603).

When the operation execution request command is received from the application selecting part 122, the controlling part 124 sends an authentication request command to the authenticating part 125 (step S604).

When the authenticating request command is received from the controlling part 124, the authenticating part 125 carries out an authentication process to permit or reject the execution (access) of the application operation (command process) requested by the operation execution request command depending on the line type information added to the authentication request command (step S605). For example, the line type information added to the authentication request command is collated with line type information that is registered in advance, and the execution of the requested application operation is permitted or rejected depending on whether the two collated line type information match. If the communication line indicated by the line type information is a network which permits the access, for example, the execution of the requested application operation is permitted. On the other hand, if the communication line indicated by the line type information is the serial I/F (USB or IEEE1394 I/F) that rejects the access, the execution of the requested application operation is rejected.

On the other hand, if the communication method type information is added to the authentication request command received from the controlling part 124, the authenticating part 125 carries out an authentication process to permit or reject the execution (access) of the application operation (command process) requested by the operation execution request command depending on the communication method type information added to the authentication request command (step S605). For example, the communication method type information added to the authentication request command is collated with communication method type information that is registered in advance, and the execution of the requested application operation is permitted or rejected depending on whether the two collated communication method type information match. If the communication method indicated by the communication method type information is a communication method that uses a network which permits the access, for example, the execution of the requested application operation is permitted. On the other hand, if the communication method indicated by the communication method type information is a communication method that uses the serial I/F (USB or IEEE1394 I/F) that rejects the access, the execution of the requested application operation is rejected.

Hence, the CPU 101 of the MPU 10 functions as a communication line type judging means and/or a communication method type judging means.

After making the authentication process described above, the authenticating part 125 sends to the controlling part 124 an authentication result notification command including information indicating the result of the authentication (step S606).

When the authentication result notification command is received from the authenticating part 125, the controlling part 124 judges contents of the authentication result notification command, and if it is recognized that the access is permitted, the controlling part 124 executes the application operation requested by the operation execution request command that has been received (step S607). The controlling part 124 then issues and sends to the application selecting part 122 a process result notification command including information indicating the result of executing the application operation (step S608).

When the process result notification command is received from the controlling part 124, the application selecting part 122 sends this process result notification command to the communication processing part 121 (step S609).

When the process result notification command is received from the application selecting part 122, the communication processing part 121 sends this process result notification command to the external application 231 (step S610).

If the controlling part 124 recognizes from the contents of the authentication result notification command received from the authenticating part 125 that the access is rejected, the controlling part 124 issues and sends to the application selecting part 122 an access rejection notification command (process result notification command) including information indicating that the access to the requested application operation has been rejected.

If the access rejection notification command is received from the controlling part 124, the application selecting part 122 sends this access rejection notification command to the communication processing part 121.

If the access rejection notification command is received from the application selecting part 122, the communication processing part 121 sends this access rejection notification command to the external application 231.

According to this sixth control example, it is possible to obtain effects similar to those obtainable in the first control example described above. However, when each of the image processing apparatuses, including the MFP 10, receives the operation execution request command from the external application, the type of communication line which transferred the operation execution request command or the type of communication method used therefor is judged, and the execution of the application operation requested by the operation execution request command is permitted or rejected depending on the result of this judgement. For this reason, it is possible to more positively exclude the invalid access from the external application.

### SEVENTH CONTROL EXAMPLE

If there exists a server which includes an external application that repeats invalid accesses (makes certain notifications), the CPU 101 of the MFP 10 may regard this server as a dangerous server and reject access from all applications of this dangerous server, including the external application which repeats the invalid accesses.

As one method of judging the dangerous server, for example, it is possible to count the number of retries of the invalid access, and to reject the access if the counted number of retries exceeds a predetermined value (certain limit value).

For example, in order to avoid danger, it is possible to employ a method that rejects access from all external applications if an invalid access is repeated.

As a method of judging that the access should be rejected, there is a method that rejects the access if an invalid access occurs a predetermined number of times or more within a predetermined (constant) time or, if an invalid access is received from a specific server a predetermined number of times or more.

Next, a description will be given of the control including the judgement to judge whether or not the access should be rejected.

When an operation execution request command is received from the external server 20, the CPU 101 of the MFP 10 judges whether or not this operation execution request command is a normal command, and counts the number of times this operation execution request command is not a normal command or, is an abnormal command (number of retries of the invalid access). If the counted number of times the operation execution request command is not a normal command exceeds a predetermined value within a predetermined time, the execution of the application operation requested by the operation execution request command is rejected. Alternatively, when the operation execution request command is received from the external server 20, the CPU 101 of the MFP 10 judges the source (external server 20) which issued this operation execution request command, and judges whether or not this operation execution request command is a normal command and counts the number of times this operation execution request command is not a normal command (number of retries of the invalid access) only when the source is a specific external server 20 that is preset. In this case, the execution of the application operation requested by the operation execution request command is rejected if the counted number of times the operation execution request command is not a normal command exceeds a predetermined value. Hence, the CPU 101 functions as an execution request judging means for judging whether the operation execution request command is a normal command or an abnormal command, and functions as an abnormality counting means for counting the number of times the operation execution request command is not normal (or is abnormal).

According to this seventh control example, it is possible to obtain effects similar to those obtainable in the first control example described above. However, when each of the image processing apparatus, including the MFP 10, receives the operation execution request command from the external application, a judgement is made to determine whether or not this operation execution request command is a normal command, and the number of times this operation execution request command is not a normal command is counted. Since the execution of the requested application operation is rejected if the counted number of times the operation execution request command is not the normal command exceeds a predetermined value, it is possible to realize a more strict application access management.

### EIGHTH CONTROL EXAMPLE

The first through seventh control examples may be combined as described in the following under items (C1) through (C10).
(C1) The first control example (upon reception of the operation execution request command) and the second control example (upon reception of the connection request command) may be combined.

In this case, the CPU 101 of the MFP 10 carries out the process of the steps S301 through S313 shown in FIG. 26, before carrying out the process of the steps S201 through S214 shown in FIG. 21, and thereafter repeats the process of the steps S201 through S214.
(C2) The second control example and the fourth control example may be combined.

In this case, the CPU 101 of the MFP 10 carries out the process of the steps S301 through S313 shown in FIG. 26 before carrying out the process of the steps S501 through S517 shown in FIG. 30, and thereafter repeats the process of the steps S501 through S517.
(C3) The first control example and the third control example (password) may be combined.

In this case, the CPU 101 of the MFP 10 carries out the process of the steps S401 through S415 shown in FIG. 28 before carrying out the process of the steps S201 through S214 shown in FIG. 21, and thereafter repeats the process of the steps S201 through S214.
(C4) The third control example and the fourth control example may be combined.

In this case, the CPU 101 of the MFP 10 carries out the process of the steps S401 through S415 shown in FIG. 28 before carrying out the process of the steps S501 through S517 shown in FIG. 30, and thereafter repeats the process of the steps S501 through S517.
(C5) The second control example and the fifth control example may be combined.

In this case, the CPU 101 of the MFP 10 carries out the process of the steps S301 through S313 shown in FIG. 26, and thereafter carries out the authentication process of the fifth control example every time the operation execution request command is received.
(C6) The third control example and the fifth control example may be combined.

In this case, the CPU 101 of the MFP 10 carries out the process of the steps S401 through S415 shown in FIG. 28, and thereafter carries out the authentication process of the fifth control example every time the operation execution request command is received.
(C7) The second control example and the sixth control example may be combined.

In this case, the CPU 101 of the MFP 10 carries out the process of the steps S301 through S313 shown in FIG. 26 before carrying out the process of the steps S601 through S610 shown in FIG. 32, and thereafter repeats the process of the steps S601 through S610.
(C8) The third control example and the sixth control example may be combined.

In this case, the CPU 101 of the MFP 10 carries out the process of the steps S401 through S415 shown in FIG. 28 before carrying out the process of the steps S601 through S610 shown in FIG. 32, and thereafter repeats the process of the steps S601 through S610.
(C9) The second control example and the seventh control example may be combined.

In this case, the CPU 101 of the MFP 10 carries out the process of the steps S301 through S313 shown in FIG. 26, and thereafter carries out the process of the seventh control example every time the operation execution request command is received.
(C10) The third control example and the seventh control example may be combined.

In this case, the CPU 101 of the MFP 10 carries out the process of the steps S401 through S415 shown in FIG. 28, and thereafter carries out the process of the seventh control example every time the operation execution request command is received.

Actually, the authentication process that is required differs depending on whether the MFP 10 (or other image processing apparatus) and the external application make the communication in a 1:1 relationship or a 1:N (1:many) relationship.

If the MFP 10 and the external application make the communication in the 1:1 relationship (that is, communicate via the USB, IEEE1394, etc.), the MFP 10 can carry out the control according to any of the first through eighth control examples.

On the other hand, if the MFP 10 and the external applications make the communication in the 1:N (1:many) relationship (that is, communicate via a network, etc. ), the MFP 10 can carry out the control according to any one of the first and fourth through seventh control examples (carry out the process such as the authentication process to confirm the validity of each operation execution request command sent from the external application), but cannot carry out the control according to the second, third and eighth control examples.

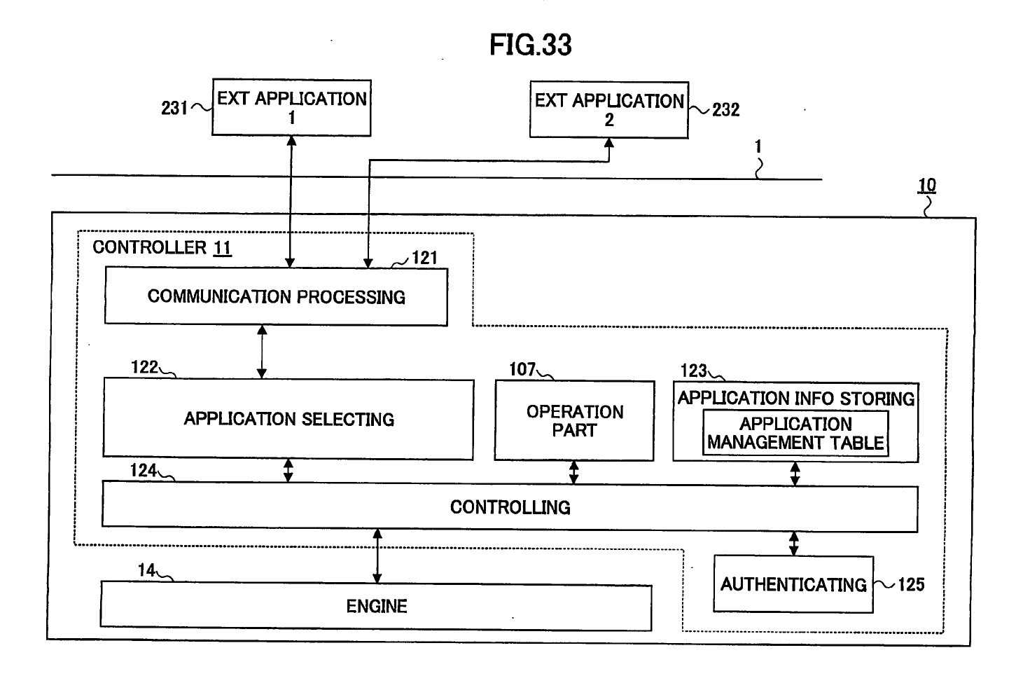

In addition, the MFP 10 may execute the application operation using only the external application, by not implementing the internal application in the controller 11 of the MFP 10 as shown in FIG. 33. FIG. 33 is a system block diagram showing another functional structure of the important part of the MFP 10 of the second embodiment. In FIG. 33, those parts that are the same as those corresponding parts in FIGS. 18 and 20 are designated by the same reference numerals, and a description thereof will be omitted. The other image processing apparatuses may have a structure similar to that of the MFP 10 shown in FIG. 33.

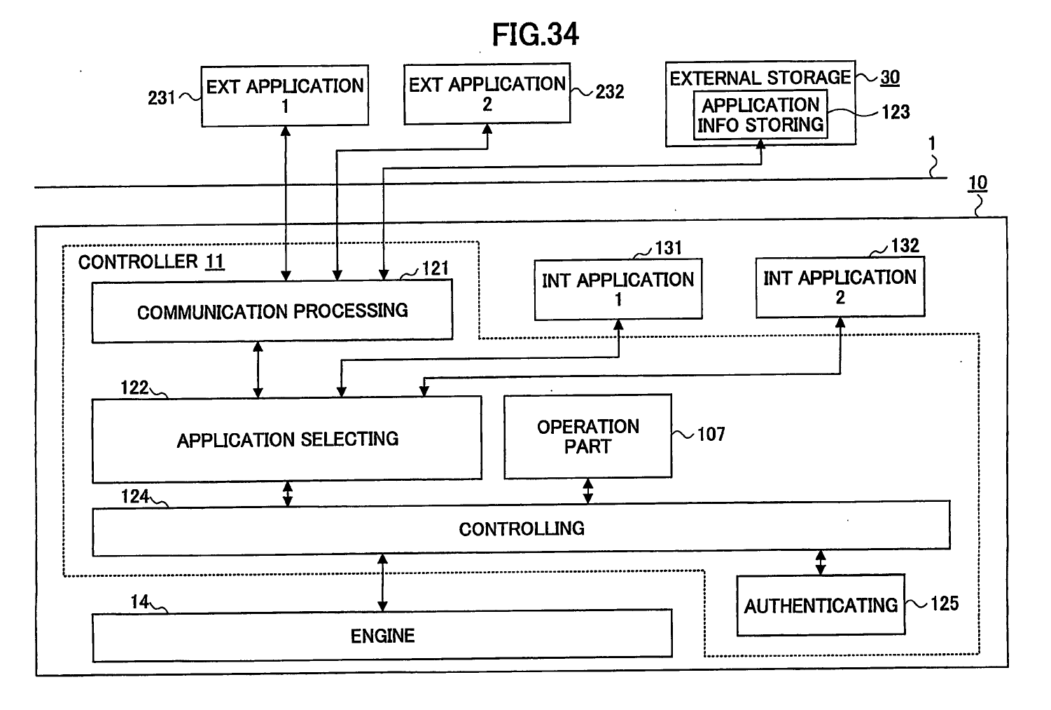

Furthermore, the MFP 10 may not be provided with the application information storing part 123 in the controller 11, and the application information storing part 123 may be provided in an external storage apparatus 30 that is connected to the MFP 10 via the network 1, as shown in FIG. 34, for example. FIG. 34 is a system block diagram showing still another functional structure of the important part of the MFP 10 of the second embodiment. In FIG. 34, those parts that are the same as those corresponding parts in FIGS. 19 and 20 are designated by the same reference numerals, and a description thereof will be omitted. In this case, the MFP 10 can make access to the application information storing part 123 by communicating with the external storage apparatus 30, and write or read information related to the internal application or external application. The other image processing apparatuses may have a structure similar to that of the MFP 10 shown in FIG. 34.

Moreover, the MFP 10 may use the external application 231 or 232 by being communicatably connected to the external application 231 or 232 via another interface such as the USB I/F 109 and the IEEE1394 I/F 110. Of course, the other image processing apparatuses may have a structure similar to that of such a MFP 10.

In the embodiments described heretofore, the present invention is applied to the image forming system (electronic apparatus system) in which the image processing apparatuses such as the MFP (digital composite apparatus) having the communicating function and the external servers are communicatably connected. However, the application of the present invention is not limited to such. For example, the present invention is also applicable to electronic apparatus systems in which electronic apparatuses having the communicating function, such as network home appliances, automatic vending machines, medial equipments, power supply-units, air conditioning systems, measuring systems for has, water, electricity and the like, audio visual equipments and game apparatuses, are communicatably connected to the external servers.

In addition, a computer-readable storage medium (or a computer program product) according to the present invention stores at least one program that is to be executed by a computer (CPU) of the image processing apparatus such as the MFP and cause the computer to function as (or to carry out procedures corresponding to) the communicating means, the application information registering means, the controlling means, the device start notification sending means, the transmission permitting means (connection permitting means) the device usability notification sending means (connection permission notification sending means), the authenticating means, the operation execution permitting means, the identification information setting means, the operation execution permitting or rejecting means, the communication line type judging means, the communication method type judging means, the execution request judging means and the abnormality counting means. The effects of the present invention described above are also obtainable by causing the computer to execute such a program stored in the computer-readable storage medium which may be formed by any suitable computer-readable storage media capable of storing the program in a computer-readable manner.

The program may be prestored in a storage means such as the ROM and HDD that are provided in the computer. Alternatively, the program may be provided in a form recorded in a recording medium such as CD-ROMs, flexible disks, SRAMs, EEPROMs, and nonvolatile recording media (memories) such as memory cards. The program stored in such a recording medium may be installed in the computer and executed by the CPU or, it is possible to cause the CPU to read the program from the recording medium and execute the read program, so as to carry out the procedures corresponding to each of the above described means so as to cause the CPU to realize the functions (or facilities) corresponding to each of the above described means.

In addition, the program may be downloaded via network from an external equipment that is provided with the recording medium storing the program or, an external equipment storing the program in a storage means.

Therefore, the present invention is suitably applicable the electronic apparatuses such as the image processing apparatuses, the computers of the electronic apparatuses, and the electronic apparatus systems in which the electronic apparatuses and the external apparatuses are connected via communication lines, where the image processing apparatuses include image reading apparatuses such as scanner apparatuses, digital copying apparatuses, printers, facsimile apparatuses, and image forming apparatuses such as digital composite apparatuses (MFPs).

Further, the present invention is not limited to these embodiments, but various variations and modifications may be made without departing from the scope of the present invention.

1. An electronic apparatus for executing an operation using an application, comprising:
communicating means for communicating with an external apparatus via a communication line; and
controlling means for executing an operation using an application within the external apparatus by communicating with the external apparatus by the communicating means

2. The electronic apparatus as claimed in claim 1, further comprising:
device start notification sending means for sending a start notification of the electronic apparatus to the external apparatus by the communicating means; and
application information registering means for registering information related to a usable application that is added to an application usability notification, when the application usability notification from the external application is received by the communicating means in response to the start notification sent by the device start notification sending means.

3. The electronic apparatus as claimed in claim 2, wherein the device start notification sending means sends the start notification to the external apparatus when a power of the electronic apparatus is turned ON.

4. The electronic apparatus as claimed in claim 1, wherein the controlling means executes the operation when an operation execution request that requests execution of the operation using the application within the external apparatus is received from the external apparatus by the communicating means.

5. The electronic apparatus as claimed in claim 4, further comprising:
authenticating means for carrying out an authentication process to confirm validity of the operation execution request when the communicating means receives the operation execution request from the external apparatus; and
operation execution permitting means for permitting execution of the operation if the authenticating means confirms that the operation execution request is valid.

6. The electronic apparatus as claimed in claim 5, wherein the authenticating means carries out the authentication process using authentication information that is added to the operation execution request.

7 The electronic apparatus as claimed in claim 6, wherein:
the authentication information is identification information unique to the application; and
the authenticating means confirms that the operation execution request is valid if the identification information matches identification information that is registered in advance.

8. The electronic apparatus as claimed in claim 6, wherein:
the authentication information is type information indicating a type of the application; and
the authenticating means confirms that the operation execution request is valid if the type information matches type information that is registered in advance.

9. The electronic apparatus as claimed in claim 6, wherein:
the authentication information includes identification information unique to the application and type information indicating a type of the application; and
the authenticating means confirms that the operation execution request is valid if the identification information matches identification information that is registered in advance and the type information matches type information that is registered in advance.

10. The electronic apparatus as claimed in claim 4, further comprising:
identification information setting means for setting identification information unique to the application with respect to which an access to the electronic apparatus is permitted or rejected; and
operation execution permitting or rejecting means for permitting or rejecting the execution of the operation requested by the operation execution request, if identification information unique to the application and added to the operation execution request matches the identification information set by the identification information setting means.

11. The electronic apparatus as claimed in claim 4, further comprising:
line type judging means for judging a type of communication line via which the operation execution request is received by the communicating means; and
operation execution permitting or rejecting means for permitting or rejecting the execution of the operation requested by the operation execution request depending on a judgement result of the line type judging means.

12. The electronic apparatus as claimed in claim 4, further comprising:
execution request judging means for judging whether the operation execution request is a normal request or an abnormal request;
abnormality counting means for counting a number of times the abnormal request is judged by the execution request judging means; and
operation execution rejecting means for rejecting the execution of the operation requested by the operation execution request if a counted value counted by the abnormality counting means exceeds a predetermined value.

13. The electronic apparatus as claimed in claim 1, further comprising:
device usability notification sending means for sending to the external apparatus a usability notification indicating a usability of the electronic apparatus when the communicating means receives a connection request from the external apparatus,
wherein the controlling means executes the operation when an operation execution request that requests execution of the operation using the application within the external apparatus is received from the external apparatus by the communicating means in response to the usability notification sent to the external apparatus by the device usability notification sending means.

14. The electronic apparatus as claimed in claim 13, further comprising:
application information registering means for registering information related to a usable application that is added to the connection request, when the connection request from the external application is received by the communicating means

15. The electronic apparatus as claimed in claim 13, further comprising:
authenticating means for carrying out an authentication process to confirm validity of the connection request when the communicating means receives the connection request from the external apparatus; and
transmission permitting means for permitting sending of the usability notification if the authenticating means confirms that the connection request is valid.

16. The electronic apparatus as claimed in claim is, wherein the authenticating means carries out the authentication process using authentication information that is added to the connection request.

17. The electronic apparatus as claimed in claim 16, wherein:
the authentication information is identification information unique to the application; and
the authenticating means confirms that the connection request is valid if the identification information matches identification information that is registered in advance.

18. The electronic apparatus as claimed in claim 13, wherein the communicating means carries out a communication sequence for confirming validity of a connection request according to a protocol that is predetermined between the electronic apparatus and the external apparatus when the connection request is received from the external apparatus, and further comprising:
authenticating means for carrying out an authentication process to confirm validity of the connection request from the communication sequence carried out by the communicating means; and
transmission permitting means for permitting the device usability notification sending means to send the device usability notification if the authenticating means confirms that the connection request is valid.

19. The electronic apparatus as claimed in claim 18, wherein the authenticating means confirms that the connection request is valid if the communication sequence is in accordance with the protocol.

20. The electronic apparatus as claimed in claim 13, further comprising:
first authenticating means for carrying out a first authentication process to confirm validity of a connection request when the communicating means receives the connection request from the external apparatus;
transmission permitting means for permitting the device usability notification sending means to send the device usability notification if the first authenticating means confirms that the connection request is valid;
second authenticating means for carrying out a second authentication process to confirm validity of the operation execution request when the communicating means receives the operation execution request from the external apparatus in response to the device usability notification sent by the device usability notification sending means; and
operation execution permitting means for permitting execution of the operation if the second authenticating means confirms that the operation execution request is valid.

21. The electronic apparatus as claimed in claim 13, wherein the communicating means carries out a communication sequence for confirming validity of a connection request according to a protocol that is predetermined between the electronic apparatus and the external apparatus when the connection request is received from the external apparatus, and further comprising:
first authenticating means for carrying out a first authentication process to confirm validity of the connection request from the communication sequence carried out by the communicating means; and
transmission permitting means for permitting the device usability notification sending means to send the device usability notification if the first authenticating means confirms that the connection request is valid;
second authenticating means for carrying out a second authentication process to confirm validity of the operation execution request when the communicating means receives the operation execution request from the external apparatus in response to the device usability notification sent by the device usability notification sending means; and
operation execution permitting means for permitting execution of the operation if the second authenticating means confirms that the operation execution request is valid.

22. An electronic apparatus system in which the electronic apparatus of claim 2 and the external apparatus are communicatably coupled via a communication line, said external apparatus comprising:
application storing means;
an other communicating means for communicating with the electronic apparatus via the communication line; and
application usability notification sending means for adding information that is related to the usable application and is stored in the application storing means to the application usability notification before sending the application usability notification to the electronic apparatus by the other communicating means, when the other communicating means receives the start notification from the electronic apparatus.

23. An electronic apparatus system in which the electronic apparatus of claim 4 and the external apparatus are communicatably coupled via a communication line, said external apparatus comprising:
application storing means;
an other communicating means for communicating with the electronic apparatus via the communication line; and
operation execution request sending means for sending the operation execution request that requests execution of the operation using a usable application stored in the application storing means to the electronic apparatus by the other communicating means.

24. An electronic apparatus system in which the electronic apparatus of claim 13 and the external apparatus are communicatably coupled via a communication line, said external apparatus comprising:
application storing means;
an other communicating means for communicating with the electronic apparatus via the communication line;
connection request sending means for sending a connection request to the electronic apparatus by the other communicating means; and
operation execution request sending means for sending the operation execution request that requests execution of the operation using a usable application stored in the application storing means to the electronic apparatus by the other communicating means when the usability notification is received from the electronic apparatus in response to the connection request sent by the connection request sending means.

25. The electronic apparatus system as claimed in claim 24, wherein the connection request sending means sends the connection request to the electronic apparatus by the other communicating means when starting the application.

26. The electronic apparatus system as claimed in claim 24, wherein said external apparatus further comprises operation means, and the connection request sending means sends the connection request to the electronic apparatus by the other communicating means in response to an operation by the operation means.

27. An electronic apparatus system in which the electronic apparatus of claim 14 and the external apparatus are communicatably coupled via a communication line, said external apparatus comprising:
application storing means;
an other communicating means for communicating with the electronic apparatus via the communication line;
connection request sending means for sending the connection request to the electronic apparatus by the other communicating means; and
operation execution request sending means for sending the operation execution request that requests execution of the operation using a usable application stored in the application storing means to the electronic apparatus by the other communicating means when the usability notification is received from the electronic apparatus in response to the connection request sent by the connection request sending means.

28. An electronic apparatus system in which the electronic apparatus of claim 13 and the external apparatus are communicatably coupled via a communication line, said external apparatus comprising:
operation means;
application storing means;
an other communicating means for communicating with the electronic apparatus via the communication line;
connection request sending means for sending a connection request to the electronic apparatus by the other communicating means;
function inquiring means for inquiring an existence of a function specified by the operation means to the electronic apparatus by the other communicating means, when the usability notification is received from usable electronic apparatuses in response to the connection request sent by the connection request sending means;
device selecting means for selecting an electronic apparatus capable of realizing the specified function from the usable electronic apparatuses, when an inquiry result is received in response to the inquiring made by the function inquiring means; and
operation execution request sending means for sending the operation execution request that requests execution of the operation using a usable application stored in the application storing means, by the other communicating means, to the electronic apparatus selected by the device selecting means.

29. A control method for an electronic apparatus which executes an operation using an application, comprising:
communicating with an external apparatus via a communication line; and
executing an operation using an application within the external apparatus.

30. The control method for the electronic apparatus as claimed in claim 29, further comprising:
sending a start notification of the electronic apparatus to the external apparatus; and
registering information related to a usable application that is added to an application usability notification, when the application usability notification from the external application is received in response to the start notification.

31. The control method for the electronic apparatus as claimed in claim 30, wherein the start notification is sent to the external apparatus when a power of the electronic apparatus is turned ON.

32. The control method for the electronic apparatus as claimed in claim 29, further comprising:
executing the operation when an operation execution request that requests execution of the operation using the application within the external apparatus is received from the external apparatus.

33. The control method for the electronic apparatus as claimed in claim 32, further comprising:
carrying out an authentication process to confirm validity of the operation execution request when the operation execution request is received from the external apparatus; and
permitting execution of the operation if the authentication process confirms that the operation execution request is valid.

34. The control method for the electronic apparatus as claimed in claim 32, further comprising:
setting identification information unique to the application with respect to which an access to the electronic apparatus is permitted or rejected; and
permitting or rejecting the execution of the operation requested by the operation execution request, if identification information unique to the application and added to the operation execution request matches the set identification information.

35. The control method for the electronic apparatus as claimed in claim 32, further comprising:
judging a type of communication line via which the operation execution request is received; and
permitting or rejecting the execution of the operation requested by the operation execution request depending on a judgement result of judging the type of communication line.

36. The control method for the electronic apparatus as claimed in claim 32, further comprising:
judging whether the operation execution request is a normal request or an abnormal request;
counting a number of times the abnormal request is judged; and
rejecting the execution of the operation requested by the operation execution request if a counted value of the abnormal request exceeds a predetermined value.

37. The control method for the electronic apparatus as claimed in claim 29, further comprising:
sending to the external apparatus a usability-notification indicating a usability of the electronic apparatus when a connection request is received from the external apparatus,
wherein the operation is executed when an operation execution request that requests execution of the operation using the application within the external apparatus is received from the external apparatus in response to the usability notification sent to the external apparatus.

38. The control method for the electronic apparatus as claimed in claim 37, further comprising:
registering information related to a usable application that is added to the connection request when the connection request is received from the external application.

39. The control method for the electronic apparatus as claimed in claim 37, further comprising:
carrying out an authentication process to confirm validity of the connection request when the connection request is received from the external apparatus; and
permitting sending of the usability notification if the authenticating process confirms that the connection request is valid.

40. The control method for the electronic apparatus as claimed in claim 37, further comprising:
carrying out a communication sequence for confirming validity of a connection request according to a protocol that is predetermined between the electronic apparatus and the external apparatus when the connection request is received from the external apparatus;
carrying out an authentication process to confirm validity of the connection request from the communication sequence; and
permitting sending of the device usability notification if the authenticating process confirms that the connection request is valid.

41. The control method for the electronic apparatus as claimed in claim 37, further comprising:
carrying out a first authentication process to confirm validity of a connection request when the connection request is received from the external apparatus;
permitting sending of the device usability notification if the first authenticating process confirms that the connection request is valid;
carrying out a second authentication process to confirm validity of the operation execution request when the operation execution request is received from the external apparatus in response to the device usability notification; and
permitting execution of the operation if the second authenticating process confirms that the operation execution request is valid.

42. The control method for the electronic apparatus as claimed in claim 37, further comprising:
carrying out a communication sequence for confirming validity of a connection request according to a protocol that is predetermined between the electronic apparatus and the external apparatus when the connection request is received from the external apparatus;
carrying out a first authentication process to confirm validity of the connection request from the communication sequence; and
permitting sending of the device usability notification if the first authenticating process confirms that the connection request is valid;
carrying out a second authentication process to confirm validity of the operation execution request when the operation execution request is received from the external apparatus in response to the device usability notification; and
permitting execution of the operation if the second authenticating process confirms that the operation execution request is valid.

43. A computer-readable storage medium which stores a program for causing a computer of an electronic apparatus to execute an operation using an application, said program comprising procedures for causing the computer to realize:
a communicating function for communicating with an external apparatus via a communication line; and
a controlling function for executing an operation using an application within the external apparatus by communicating with the external apparatus by the communicating function.

44. The computer-readable storage medium as claimed in claim 43, wherein the program further comprises procedures for causing the computer to realize:
a device start notification sending function for sending a start notification of the electronic apparatus to the external apparatus by the communicating function; and
an application information registering function for registering information related to a usable application that is added to an application usability notification, when the application usability notification from the external application is received by the communicating function in response to the start notification sent by the device start notification sending function.

45. The computer-readable storage medium as claimed in claim 44, wherein the device start notification sending function sends the start notification to the external apparatus when a power of the electronic apparatus is turned ON.

46. The computer-readable storage medium as claimed in claim 43, wherein the controlling function executes the operation when an operation execution request that requests execution of the operation using the application within the external apparatus is received from the external apparatus by the communicating function.

47. The computer-readable storage medium as claimed in claim 46, wherein the program further comprises procedures for causing the computer to realize:
an authenticating function for carrying out an authentication process to confirm validity of the operation execution request when the communicating function receives the operation execution request from the external apparatus; and
an operation execution permitting function for permitting execution of the operation if the authenticating function confirms that the operation execution request is valid.

48. The computer-readable storage medium as claimed in claim 47, wherein the authenticating function carries out the authentication process using authentication information that is added to the operation execution request.

49. The computer-readable storage medium as claimed in claim 48, wherein:
the authentication information is identification information unique to the application; and
the authenticating function confirms that the operation execution request is valid if the identification information matches identification information that is registered in advance.

50. The computer-readable storage medium as claimed in claim 48, wherein:
the authentication information is type information indicating a type of the application; and
the authenticating function confirms that the operation execution request is valid if the type information matches type information that is registered in advance.

51. The computer-readable storage medium as claimed in claim 48, wherein:
the authentication information includes identification information unique to the application and type information indicating a type of the application; and
the authenticating function confirms that the operation execution request is valid if the identification information matches identification information that is registered in advance and the type information matches type information that is registered in advance.

52. The computer-readable storage medium as claimed in claim 46, wherein the program further comprises procedures for causing the computer to realize:
an identification information setting function for setting identification information unique to the application with respect to which an access to the electronic apparatus is permitted or rejected; and
an operation execution permitting or rejecting function for permitting or rejecting the execution of the operation requested by the operation execution request, if identification information unique to the application and added to the operation execution request matches the identification information set by the identification information setting function.

53. The computer-readable storage medium as claimed in claim 46, wherein the program further comprises procedures for causing the computer to realize:
a line type judging function for judging a type of communication line via which the operation execution request is received by the communicating function; and
an operation execution permitting or rejecting function for permitting or rejecting the execution of the operation requested by the operation execution request depending on a judgement result of the line type judging function.

54. The computer-readable storage medium as claimed in claim 46, wherein the program further comprises procedures for causing the computer to realize:
an execution request judging function for judging whether the operation execution request is a normal request or an abnormal request;
an abnormality counting function for counting a number of times the abnormal request is judged by the execution request judging function; and
an operation execution rejecting function for rejecting the execution of the operation requested by the operation execution request if a counted value counted by the abnormality counting function exceeds a predetermined value.

55. The computer-readable storage medium as claimed in claim 43, wherein the program further comprises procedures for causing the computer to realize:
a device usability notification sending function for sending to the external apparatus a usability notification indicating a usability of the electronic apparatus when the communicating function receives a connection request from the external apparatus,
wherein the controlling function executes the operation when an operation execution request that requests execution of the operation using the application within the external apparatus is received from the external apparatus by the communicating function in response to the usability notification sent to the external apparatus by the device usability notification sending function.

56. The computer-readable storage medium as claimed in claim 55, wherein the program further comprises procedures for causing the computer to realize:
an application information registering function for registering information related to a usable application that is added to the connection request, when the connection request from the external application is received by the communicating function.

57. The computer-readable storage medium as claimed in claim 55, wherein the program further comprises procedures for causing the computer to realize:
an authenticating function for carrying out an authentication process to confirm validity of the connection request when the communicating function receives the connection request from the external apparatus; and
a transmission permitting function for permitting sending of the usability notification if the authenticating function confirms that the connection request is valid.

58. The computer-readable storage medium as claimed in claim 57, wherein the authenticating function carries out the authentication process using authentication information that is added to the connection request.

59. The computer-readable storage medium as claimed in claim 58, wherein:
the authentication information is identification information unique to the application; and
the authenticating function confirms that the connection request is valid if the identification information matches identification information that is registered in advance.

60. The computer-readable storage medium as claimed in claim 55, wherein the communicating function carries out a communication sequence for confirming validity of a connection request according to a protocol that is predetermined between the electronic apparatus and the external apparatus when the connection request is received from the external apparatus, and the program further comprises procedures for causing the computer to realize:
an authenticating function for carrying out an authentication process to confirm validity of the connection request from the communication sequence carried out by the communicating function; and
a transmission permitting function for permitting the device usability notification sending function to send the device usability notification if the authenticating function confirms that the connection request is valid.

61. The computer-readable storage medium as claimed in claim 60, wherein the authenticating function confirms that the connection request is valid if the communication sequence is in accordance with the protocol.

62. The computer-readable storage medium as claimed in claim 55, wherein the program further comprises procedures for causing the computer to realize:
a first authenticating function for carrying out a first authentication process to confirm validity of a connection request when the communicating function receives the connection request from the external apparatus;
a transmission permitting function for permitting the device usability notification sending function to send the device usability notification if the first authenticating function confirms that the connection request is valid;
a second authenticating function for carrying out a second authentication process to confirm validity of the operation execution request when the communicating function receives the operation execution request from the external apparatus in response to the device usability notification sent by the device usability notification sending function; and
an operation execution permitting function for permitting execution of the operation if the second authenticating function confirms that the operation execution request is valid.

63. The computer-readable storage medium as claimed in claim 55, wherein the communicating function carries out a communication sequence for confirming validity of a connection request according to a protocol that is predetermined between the electronic apparatus and the external apparatus when the connection request is received from the external apparatus, and the program further comprises procedures for causing the computer to realize:
a first authenticating function for carrying out a first authentication process to confirm validity of the connection request from the communication sequence carried out by the communicating function; and
a transmission permitting function for permitting the device usability notification sending function to send the device usability notification if the first authenticating function confirms that the connection request is valid;
a second authenticating function for carrying out a second authentication process to confirm validity of the operation execution request when the communicating function receives the operation execution request from the external apparatus in response to the device usability notification sent by the device usability notification sending function; and
an operation execution permitting function for permitting execution of the operation if the second authenticating function confirms that the operation execution request is valid.
